(19) United States
(12) Patent Application Publication
(10) Pub. No.: US 2020/0272930 A1
(43) Pub. Date: Aug. 27, 2020

(54) Quantum Artificial Neural Networks

(71) Applicant: President and Fellows of Harvard College, Cambridge, MA (US)

(72) Inventors: Alan Aspuru-Guzik, Cambridge, MA (US); Yudortg Cao, Cambridge, MA (US)

(21) Appl. No.: 16/647,194

(22) PCT Filed: Sep. 14, 2018
(86) PCT No.: PCT/US2018/051174

§ 371 Date: Mar. 13, 2020

Related U.S. Application Data
(60) Provisional application No. 62/559,084, filed on Sep. 15, 2017.
(60) Provisional application No. 62/581,858, filed on Nov. 6, 2017.

(51) Int. Cl. G06N 10/00; G06N 3/06; G06N 3/04; G06N 3/08; G06K 9/62

(52) U.S. Cl. CPC G06N 10/00; G06N 3/06; G06K 9/6256; G06N 3/082; G06N 3/0445

(57) ABSTRACT

A quantum circuit that functions a neuron and a method for configuring same. The quantum circuit comprises a Repeat-Until-Success (RUS) circuit that includes an input register, comprising at least one input qubit; an ancilla qubit; and an output qubit. The method for configuring the quantum neuron comprises: encoding an input quantum state in the at least one input qubit; and applying the first RUS circuit to the ancilla qubit and to the output qubit of the first RUS circuit, wherein the first RUS circuit is controlled by the input quantum state.

### CROSS-REFERENCE TO RELATED APPLICATIONS

This application claims the benefit of U.S. Provisional Application No. 62/559,084, filed Sep. 15, 2017, and U.S. Provisional Application No. 62/581,858, filed Nov. 6, 2017, which are hereby incorporated by reference in their entirety.

### STATEMENT REGARDING FEDERALLY SPONSORED RESEARCH OR DEVELOPMENT

This invention was made with Government support under Grant No. CHE-1655187 awarded by the National Science Foundation. The Government has certain rights to this invention.

### BACKGROUND

Embodiments of the present disclosure relate to quantum artificial neural networks, and more specifically, to quantum neurons.

### BRIEF SUMMARY

According to embodiments of the present disclosure, methods of and computer program products for configuring a quantum circuit are provided. The quantum circuit comprising a first Repeat-Until-Success (RUS) circuit that includes: an input register, comprising at least one input qubit; an ancilla qubit; and an output qubit. An input quantum state is encoded in the at least one input qubit. The first RUS circuit is applied to the ancilla qubit and to the output qubit of the first RUS circuit. The first RUS circuit is controlled by the input quantum state.

In various embodiments, a quantum state of the output qubit and the quantum state of the at least one input qubit are jointly measured.

In various embodiments, the input register of the first RUS circuit comprises a plurality of input qubits, and the first RUS circuit is controlled by a signal representing a weighted sum of quantum states of the input qubits.

In various embodiments, the quantum circuit further includes a second RUS circuit that includes: an input register, comprising at least one input qubit; an ancilla qubit; and an output qubit. The output qubit of the first RUS circuit is the input qubit of the second RUS circuit.

According to embodiments of the present disclosure, methods of and computer program products for training a Feed Forward Quantum Neural Network (FFQNN) is provided. The FFQNN comprises an input layer; optionally, one or more hidden layers, which, if existing, are in communication with the input layer; and an output layer, in communication with the one or more hidden layers, if existing, or in direct communication with the input layer otherwise, each layer including at least one qubit. A training register is provided including at least one qubit. Quantum entanglement is caused between the training layer and the input layer. An input quantum state is encoded in the input layer. The input quantum state is propagated from the input layer, optionally, through the one or more hidden layers, to the output layer. A correlated measurement is made between the at least one qubit of the training register and the at least one qubit of the output layer. The qubits of any two precedent and subsequent layers of the FFQNN that are in direct communication are configured to form a Repeat-Until-Success (RUS) circuit that includes: an input register, comprising at least one input qubit; an ancilla qubit; and an output qubit. The input register of the RUS circuit includes qubits of the precedent layer, and the output qubit of the RUS circuit are the qubits of the subsequent layer. The quantum state is propagated between the precedent and subsequent layers of the FFQNN that are in direct communication includes applying the RUS circuit, controlled by the precedent layer, to the qubits in the subsequent layer.

According to embodiments of the present disclosure, methods of and computer program products for updating a Hopfield Quantum Neural Network (HQNN) is provided. The HQNN comprises: a plurality of nodes, each node in communication with every other node, each node including at least one qubit. An input quantum state is encoded in the qubits. The HQNN is updated. Updating the HQNN comprises: designating a node as a selected node; configuring a Repeat-Until-Success (RUS) circuit that includes: an input register; an ancilla qubit; and an output qubit. The input register of the RUS circuit includes the qubits of the plurality of nodes, and the output qubit of the RUS circuit is a qubit of a new node. The RUS circuit is applied, controlled by the input register, to the qubit of the new node.

In various embodiments, the selected node is replaced with the new node.

In various embodiments, the quantum circuit further includes at least one additional qubit. A quantum state of the at least one additional qubit is encoded under a joint control of the output qubit and the at least one qubit of the input register.

According to embodiments of the present disclosure, methods of and computer program products for configuring a Quantum Autoencoder Neural Network (QANN) is provided. The QANN comprises: an input layer; at least one hidden layer in direct communication with the input layer; and an output layer, in direct communication with at least one hidden layer. Each layer includes at least one qubit. An input quantum is encoded state in the input layer. The input quantum state is propagated from the input layer, through the at least one hidden layer, to the output layer. A correlated measurement is made between the at least one qubit of the input layer and the at least one qubit of the output layer, thereby configuring the QANN. The qubits of any two precedent and subsequent layers of the QANN that are in direct communication are configured to form a Repeat-Until-Success (RUS) circuit that includes: an input register, comprising at least one input qubit; an ancilla qubit; and an output qubit. The input register of the RUS circuit includes qubits of the precedent layer and the ancilla qubit and the output qubit of the RUS circuit are the qubits of the subsequent layer. The quantum state is propagated between the precedent and subsequent layers of the QANN that are in direct communication includes applying the RUS circuit, controlled by the precedent layer, to the qubits in the subsequent layer.

According to embodiments of the present disclosure quantum circuits are provided, comprising: a first Repeat-Until-Success (RUS) circuit that includes: an input register, comprising at least one input qubit; an ancilla qubit; and an output qubit. The at least one input qubit is configured to encode an input quantum state. The first RUS circuit is configured to the ancilla qubit and to the output qubit of the first RUS circuit. The first RUS circuit is controlled by the input quantum state.

In various embodiments, the quantum circuit further includes a second RUS circuit that includes: an input register, comprising at least one input qubit; an ancilla qubit; and an output qubit. The output qubit of the first RUS circuit is the input qubit of the second RUS circuit.

In various embodiments, the quantum circuit further includes at least one additional qubit, the circuit configured to encode a quantum state of the at least one additional qubit under a joint control of the output qubit and the at least one qubit of the input register.

According to embodiments of the present disclosure, Feed Forward Quantum Neural Network (FFQNN) are provided, comprising: a training register including at least one qubit; an input layer; optionally, one or more hidden layers, which, if existing, are in communication with the input layer; and an output layer, in communication with the one or more hidden layers, if existing, or in direct communication with the input layer otherwise, each layer including at least one qubit. The training register and the input layer are configured to be in a state of quantum entanglement. The input layer is configured to encode an input quantum state. The FFQNN is configured to make a correlated measurement between the at least one qubit of the training register and the at least one qubit of the output layer. The qubits of any two precedent and subsequent layers of the FFQNN that are in direct communication are configured to form a Repeat-Until-Success (RUS) circuit that includes: an input register, comprising at least one input qubit; an ancilla qubit; and an output qubit. The input register of the RUS circuit includes qubits of the precedent layer, and the ancilla qubit and the output qubit of the RUS circuit are the qubits of the subsequent layer. The FFQNN is configured to propagate the quantum state between the precedent and subsequent layers of the FFQNN that are in direct communication by applying the RUS circuit, controlled by the precedent layer, to the qubits in the subsequent layer.

According to embodiments of the present disclosure, Hopfield Quantum Neural Network (HQNN) are provided, comprising: a plurality of nodes, each node in communication with every other node, each node including at least one qubit, the qubits configured to encode an input quantum state. The HQNN is configured to: designate a node as a selected node; form a Repeat-Until-Success (RUS) circuit that includes: an input register; an ancilla qubit; and an output qubit, wherein the input register of the RUS circuit includes the qubits of the plurality of nodes, and the output qubit of the RUS circuit is a qubit of a new node; and apply the RUS circuit, controlled by the input register, to the qubit of the new node.

In some embodiments, the Hopfield Quantum Neural Network, is further configured to replace the selected node with the new node.

According to embodiments of the present disclosure, Quantum Autoencoder Neural Network (QANN) are provided, comprising: an input layer; at least one hidden layer, in direct communication with the input layer; and an output layer, in direct communication with the at least one hidden layer, each layer including at least one qubit. The QANN is configured to: encode an input quantum state in the input layer; propagate the input quantum state from the input layer, through the at least one hidden layer, to the output layer; and to make a correlated measurement between the at least one qubit of the input layer and the at least one qubit of the output layer, thereby configuring the QANN. The qubits of any two precedent and subsequent layers of the QANN that are in direct communication are configured to form a Repeat-Until-Success (RUS) circuit that includes: an input register, comprising at least one input qubit; an ancilla qubit; and an output qubit. The input register of the RUS circuit includes qubits of the precedent layer and the ancilla qubit and the output qubit of the RUS circuit are the qubits of the subsequent layer. The QANN is configured to propagate the quantum state between the precedent and subsequent layers of the QANN that are in direct communication by applying the RUS circuit, controlled by the precedent layer, to the qubits in the subsequent layer.

### BRIEF DESCRIPTION OF THE SEVERAL VIEWS OF THE DRAWINGS

FIG. 1A is schematic view of a classical artificial neuron.

FIG. 1B is a schematic view of a quantum neuron according to embodiments of the present disclosure.

FIG. 1C is a schematic view of a repeat-until-success (RUS) circuit according to embodiments of the present disclosure.

FIG. 1D is graph of non-linear function according to embodiments of the present disclosure.

FIGS. 2A-B are schematic views of exemplary RUS circuits according to embodiments of the present disclosure.

FIG. 3 is a schematic view of an exemplary RUS circuit according to embodiments of the present disclosure.

FIG. 4A is a schematic view of forward propagation within a classical neural network.

FIG. 4B is a schematic view of a quantum circuit for quantum neuron propagation according to embodiments of the present disclosure.

FIG. 4C is a schematic view of a quantum circuit for applying a rotation according to embodiments of the present disclosure.

FIG. 5A is a schematic view of an XOR network according to embodiments of the present disclosure.

FIGS. 5B-C are graphs of accuracy results against network evaluations of an XOR network according to embodiments of the present disclosure.

FIG. 6A is a schematic view of a parity network according to embodiments of the present disclosure.

FIGS. 6B-C are graphs of accuracy results against network evaluations of a parity network according to embodiments of the present disclosure.

FIG. 7 is a schematic view of a Hopfield network update step according to embodiments of the present disclosure.

FIG. 8 is a schematic view of a circuit for approximating ReLU activation according to embodiments of the present disclosure.

FIG. 9 is a schematic view of a circuit comprising two iterations of RUS according to embodiments of the present disclosure.

FIG. 10 is a schematic view of a circuit for simulating weighted and biased input process of a neural network according to embodiments of the present disclosure.

FIG. 11 depicts a computing node according to an embodiment of the present disclosure.

### DETAILED DESCRIPTION

Machine learning systems are revolutionizing the field of data analysis and patter recognition. Their commercial deployment has already generated a very concrete change in many activities of the everyday life such as travel booking, navigation, media recommendation, image recognition and playing competitive board games. Much of the rapid development is driven by deep neural networks, together with recent improvements of training techniques and the availability of massive amounts of data and computational power. Despite their diversity, all neural networks are essentially based on a common unit from which they derive their name: the artificial neuron.

Inspired by the basic mechanism involved in neural activities of living organisms, the artificial neurons are organized in networks where the output of one neuron constitutes the inputs for other neurons. Every neuron combines the input values through a weighted sum, applies a non-linear activation function and produces the corresponding value as output. The activation function often takes the form of a step function or, in modern uses, of a continuous sigmoid function. Its non-linearity is an essential feature that makes the collective dynamics dissipative and attractor-based and contributes to the ability of neural networks to capture highly non-trivial patterns.

Independently, the advent of quantum computation has provided an entirely new perspective for thinking about how information is stored and manipulated. By taking advantage of uniquely quantum mechanical features such as superposition and entanglement, hard computational tasks can be solved with quantum computers significantly faster compared to the best-known classical algorithms. With the development of all-purpose quantum computation, the possibility has appeared for quantum neural networks (QNN), namely devices or algorithms which combine the unique features of both quantum mechanics and neural networks to perform meaningful computational tasks.

The central issue in QNN lies in the problem of incorporating the non-linear, dissipative dynamics of classical neural networks into the linear, unitary framework of quantum mechanics. Potential resolutions include introducing quantum measurements, exploiting the quadratic form of kinetic term to generate non-linearity, and using dissipative quantum gates. Other possibilities are directed to capturing certain aspects of classical neural networks such as associative memory property, but deviate in fundamental ways from classical neural networks. At present, there is no construction that fully incorporates both the unique properties of quantum mechanics and the nonlinear features of neural networks.

To address this and other shortcomings of alternative approaches, the present disclosure provides a quantum neuron and demonstrates its application as building block of quantum neural networks. Approaches here use repeat-until-success techniques for quantum gate synthesis. The model provided herein is able to simulate classical neurons with sigmoid or step function activation while processing inputs in quantum superposition. A design is provided, and the performance of classifiers and associative memories is simulated in the quantum regime. In fact, in the context of feedforward neural networks, the model provided herein can simulate a standard feedforward network and process all the training data at once in quantum superposition. For Hopfield networks, it is shown numerically that the model reproduces the attractor dynamics by converging to a unique, memorized, pattern even when starting from a quantum superposition of input states. The quantum neuron model provided herein is the first explicit construction that satisfies the criteria for a reasonable quantum neural network in a way that naturally combines the unique features of both quantum mechanics and machine learning.

As used herein, a quantum gate (or quantum logic gate) is a basic quantum circuit operating on a small number of qubits. By analogy to classical computing, quantum gates form quantum circuits, like classical logic gates form conventional digital circuits. Quantum logic gates are represented by unitary matrices. Various common quantum gates operate on spaces of one or two qubits, like classical logic gates operate on one or two bits. As matrices, quantum gates can be described by 2ⁿ×2ⁿ sized unitary matrices, where n is the number of qubits. The variables that the gates act upon, the quantum states, are vectors in 2ⁿ complex dimensions. The base vectors indicate the possible outcomes if measured, and a quantum state is a linear combinations of these outcomes. The action of the gate on a specific quantum state is found by multiplying the vector which represents the state by the matrix representing the gate. Accordingly, a given quantum state may be prepared on a quantum circuit through application of a plurality of gates. A given state may be characterized as a distribution function that provides a distribution describing a continuous random variable.

Various physical embodiments of a quantum computer are suitable for use according to the present disclosure. In general, the fundamental data storage unit in quantum computing is the quantum bit, or qubit. The qubit is a quantum-computing analog of a classical digital-computer-system bit. A classical bit is considered to occupy, at any given point in time, one of two possible states corresponding to the binary digits 0 or 1. By contrast, a qubit is implemented in hardware by a physical component with quantum-mechanical characteristics. Each unit has an infinite number of different potential quantum-mechanical states. When the state of a qubit is physically measured, the measurement produces one of two different basis states. Thus, a single qubit can represent a one, a zero, or any quantum superposition of those two qubit states; a pair of qubits can be in any quantum superposition of 4 states; and three qubits in any superposition of 8 states. While qubits are characterized herein as mathematical objects, each corresponds to a physical qubit that can be implemented using a number of different physical implementations, such as trapped ions, optical cavities, individual elementary particles, molecules, or aggregations of molecules that exhibit qubit behavior.

In some embodiments, a quantum circuit comprises nonlinear optical media. In some embodiments, a quantum circuit comprises a cavity quantum electrodynamics device. In some embodiments, a quantum circuit comprises an ion trap. In some embodiments, a quantum circuit comprises a nuclear magnetic resonance device. In some embodiments, a quantum circuit comprises a superconducting device. In some embodiments, a quantum circuit comprises a solid state device.

In contrast to classical gates, there are an infinite number of possible single-qubit quantum gates that change the state vector of a qubit. Changing the state of a qubit state vector is therefore referred to as a rotation. A rotation, state change, or single-qubit quantum-gate operation may be represented mathematically by a unitary 2×2 matrix with complex elements.

A quantum circuit can be specified as a sequence of quantum gates. To conceptualize a quantum circuit, the matrices corresponding to the component quantum gates may be multiplied together in the order specified by the symbol sequence to produce a 2×2 complex matrix representing the same overall state change. A quantum circuit may thus be expressed as a single resultant operator. However, designing a quantum circuit in terms of constituent gates allows the design to conform to standard sets of gates, and thus enable greater ease of deployment. A quantum circuit thus corresponds to a design for a physical circuit in a quantum computer.

The quantum gates making up a quantum circuit may have an associated plurality of tuning parameters. For example, in embodiments based on optical switching, tuning parameters may correspond to the angles of individual optical elements.

Gates can operate on any number of qubits, although one-qubit gates and two-qubit gates are common. Examples of one-qubit gates include the Pauli X, Y, and Z gates, which act on a single qubit and correspond to a rotation around the X, Y, or Z axis of the Bloch sphere of the qubit. One example of a two-qubit gate is a matchgate, which is defined by a 4×4 matrix. It will be appreciated that additional two-qubit gates may be defined by 4×4 unitary matrices, or in terms of their constituent rotations.

One example of a quantum state is an approximate thermal state of a quantum Hamiltonian (Hamiltonians with interactions beyond those in the classical Ising model). In general, a quantum system in thermal equilibrium is typically characterized by T, the temperature of the system, and H, the Hamiltonian of the system. The density operator describing the state of this equilibrium quantum system is

$$ρ = \frac{{e}^{- H \text{/} T}}{Z}$$

and is known as the quantum thermal state or Gibbs state. This is obtained mathematically as the density operator which maximizes the entropy of the system, consistent with the average energy of the system being a fixed value. Quantum thermal states are useful in this context in that they afford an efficient estimate of a lower bound on the KL divergence, which is used for parameter training as set out below.

Classical artificial neural networks (ANNs) are distributed computing systems, which consist of a number of neurons interconnected through connection points called synapses. Each synapse encodes the strength of the connection between the output of one neuron and the input of another. The output of each neuron is determined by the aggregate input received from other neurons that are connected to it. Thus, the output of a given neuron is based on the outputs of connected neurons from preceding layers and the strength of the connections as determined by the synaptic weights. An ANN is trained to solve a specific problem (e.g., pattern recognition) by adjusting the weights of the synapses such that a particular class of inputs produce a desired output.

Various algorithms may be used for this learning process. Certain algorithms may be suitable for specific tasks such as image recognition, speech recognition, or language processing. Training algorithms lead to a pattern of synaptic weights that, during the learning process, converges toward an optimal solution of the given problem. Backpropagation is one suitable algorithm for supervised learning, in which a known correct output is available during the learning process. The goal of such learning is to obtain a system that generalizes to data that were not available during training.

In general, during backpropagation, the output of the network is compared to the known correct output. An n error value is calculated for each of the neurons in the output layer. The error values are propagated backwards, starting from the output layer, to determine an error value associated with each neuron. The error values correspond to each neuron's contribution to the network output. The error values are then used to update the weights. By incremental correction in this way, the network output is adjusted to conform to the training data.

When applying backpropagation, an ANN rapidly attains a high accuracy on most of the examples in a training-set. The vast majority of training time is spent trying to further increase this test accuracy. During this time, a large number of the training data examples lead to little correction, since the system has already learned to recognize those examples. While in general, ANN performance tends to improve with the size of the data set, this can be explained by the fact that larger data-sets contain more borderline examples between the different classes on which the ANN is being trained.

Various classical artificial neural networks are known in the art, including feedforward neural networks, radial basis function networks, self-organizing maps, learning vector quantization, recurrent neural networks, Hopfield networks, Boltzmann machines, echo state networks, long short term memory, bi-directional recurrent neural networks, hierarchical recurrent neural network, stochastic neural networks, modular neural networks, associative neural networks, deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, and a deep Q-network.

An autoencoder is a neural network that learns to compress data from the input layer into a short code, and then uncompress that code into something that closely matches the original data. This forces the autoencoder to engage in dimensionality reduction, for example by learning how to ignore noise. Autoencoders are also useful as generative models.

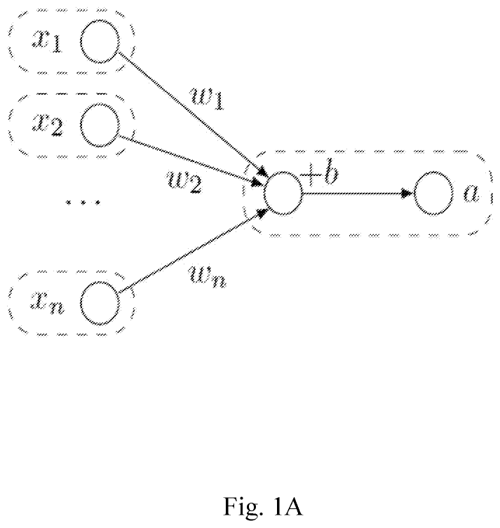

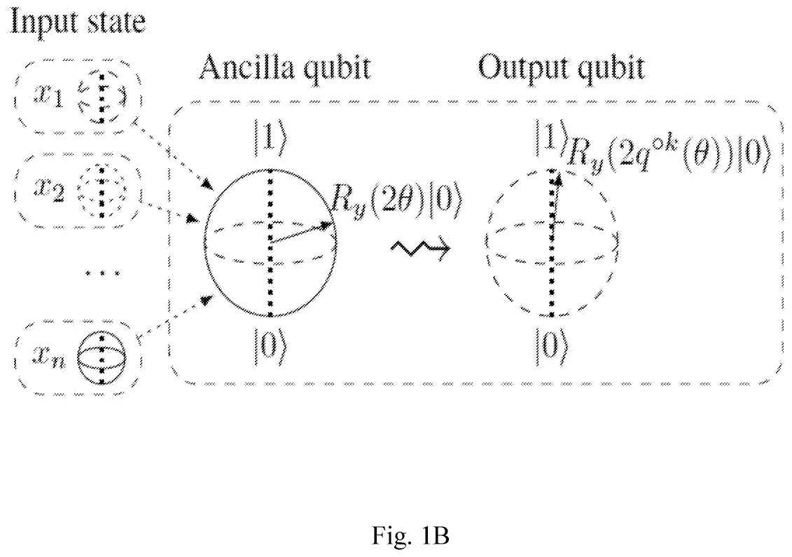

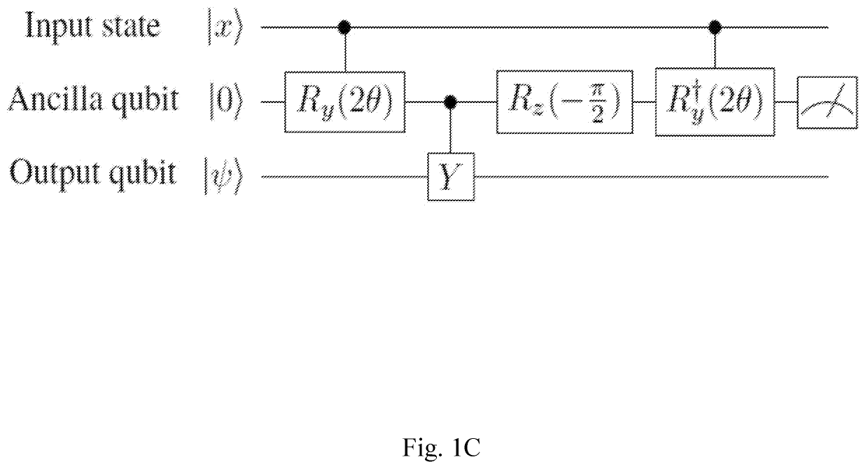

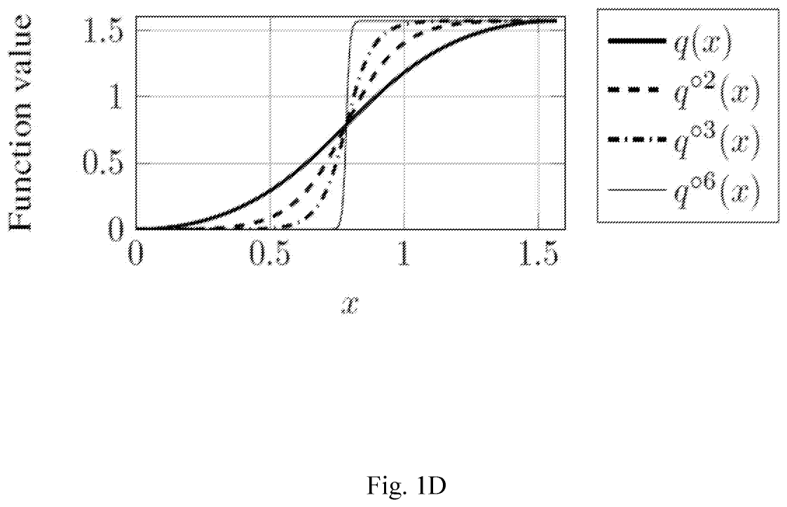

Referring to FIGS. 1A-D, a quantum neuron model is illustrated according to the present disclosure.

FIG. 1A illustrates the classical neuron (marked using dashed boxes). The inputs x₁, . . . xₙ are combined with specific weights wᵢ; and biased by b to form θ=w₁x₁+ . . . +wₙxₙ+b. The output activation is a=σ(θ), with σ being a sigmoid or step function.

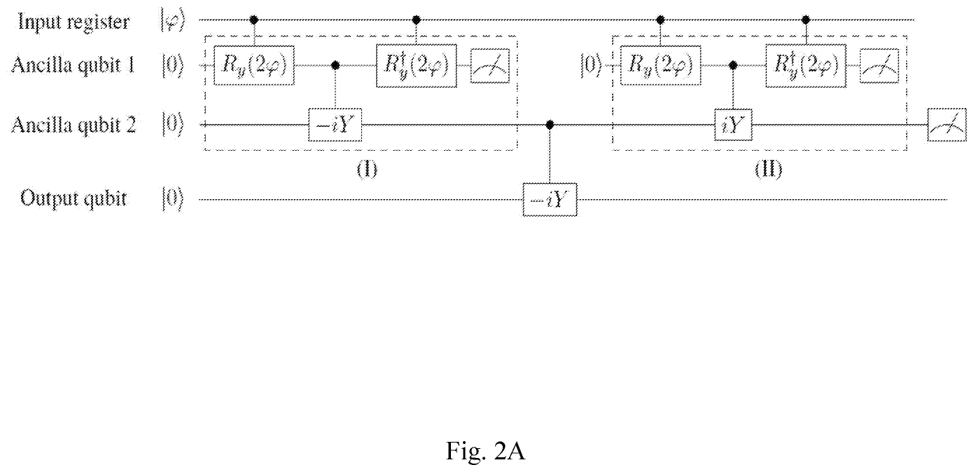

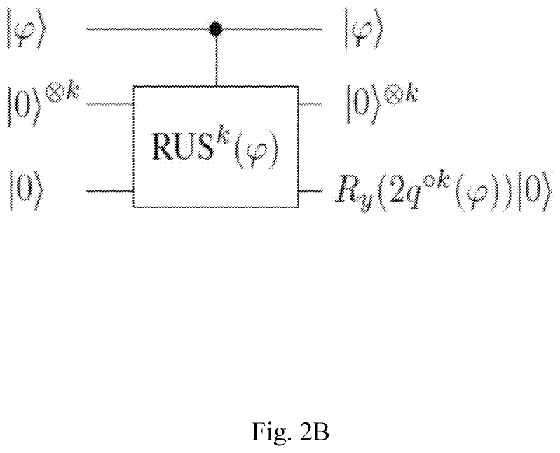

FIG. 1B illustrates the quantum neuron (marked using dashed boxes). A Bloch sphere visualization is provided of the output qubit state before and after the RUS, corresponding to the linear and non-linear activation function, respectively. The function q is shown in FIG. 2D. The notation [symbol] represents transforming the ability to perform rotation by 2θ to the ability to perform rotation by 2q^{ok}(θ) via repeat-until-success circuits. The input state is assumed to be prepared by some external method, possibly controlled by other quantum neurons.

FIG. 1C illustrates a repeat-until-success (RUS) circuit for realizing rotation with an angle q(φ)=arctan(tan² φ). The convention R^{p}(x)=exp(−ixP/2) is used where p∈{x, y, z} labels Pauli operators P∈{X, Y, Z}.

FIG. 1D illustrates the nonlinear function q(x)=arctan(tan² x) and its self-composition q^{ok}(z)=arctan(tan²^{^{k}} x).

A classical neuron is a function that takes n variables x₁, x₂, . . . , xₙ and maps them to the output value a=σ(w₁x₁+w₂x₂+ . . . +wₙxₙ+b) with and b being the synaptic weights and bias respectively (FIG. 1A). The quantity θ=w₁x₁+ . . . wₙxₙ+b is called the input signal to the neuron. The activation function σ(z) is a nonlinear function. Examples of activation functions considered in classical implementations are the step function, that returns 1 if z>0 and −1 otherwise, or continuous functions with softer nonlinearity, such as the sigmoid function

$$tanh ( z ) = \frac{{e}^{z} - {e}^{- z}}{{e}^{z} + {e}^{- z}} ,$$

or other kinds of nonlinear functions. In all cases, we say that the output value a∈[−1, 1] is the state of the neuron.

To map this setting to the quantum framework, a qubit is introduced whose quantum state is

$${R}_{y} ( a \frac{π}{2} + \frac{π}{2} ) \vert 0 〉 = cos ( a \frac{π}{4} + \frac{π}{4} ) \vert 0 〉 + sin ( a \frac{π}{4} + \frac{π}{4} ) \vert 1 〉 ,$$

where a∈[−1, 1] is a scalar and R^{g}(t)=exp(−itY/2) is a quantum operation corresponding to the rotation generated by the Pauli Y operator (see FIG. 1B). The extremal cases a=−1 and a=1 correspond to quantum states |0 [symbol] and |1 [symbol] respectively, in analogy to the classical cases with binary output. However, the case a∈(−1, 1) represents the quantum neuron in a superposition of |0 [symbol] and |1 [symbol] , which has no classical analogy.

In order to mimic, using a quantum circuit, the function of the classical neuron where inputs x₁ₛ . . . xₙ∈{0, 1} are linearly combined to form an input θ=w₁x₁+ . . . +wₙxₙ+b, one could simply use the state |x [symbol] =|x₁ . . . xₙ [symbol] as a control state and apply R^{g}(2w_{g}) onto an ancilla qubit conditioned on the i-th qubit, followed by R_{g}(2b) on the ancilla qubit. This amounts to applying the R^{g}(2θ) on the ancilla qubit conditioned on the state |x [symbol] of the input neurons (FIGS. 1B-C). The second step is to perform a rotation by R_{g}(σ(θ)) where σ is a non-linear function (either sigmoid or threshold function). In various embodiments, such rotation is approximated by a class of circuits called repeat-until-success (RUS) circuits. FIG. 1C shows a circuit that implements R^{g}(q(θ)) where q(θ)=arctan(tan² θ) is a sigmoid-like non-linear function (FIG. 1D). The action of an RUS circuit on the output qubit depends on the measurement outcome of the ancilla qubit.

If the measurement returns |0 [symbol] , this indicates that the rotation by 2q^{ok}9θ) has been successfully applied to the output qubit.

Otherwise, if the ancilla qubit measures |1 [symbol] , this indicates that the circuit has implemented a rotation Ry (π/2) onto the output qubit. In this case we correct the operation by applying R_{g}(π/2) and then repeat the circuit until |0 [symbol] is measured in the ancilla qubit, thus the name, repeat until success.

Referring to FIGS. 2A-B, exemplary RUS circuits are illustrated. In FIG. 2A, two iterations of the RUS circuit shown in FIG. 1C are shown. Here R_{z} rotation in FIG. 1C is absorbed into an additional phase of the controlled Y operation. In FIG. 2B, a general k-iteration RUS circuit is shown. The circuit in FIG. 2A can be considered as a special case k=2.

Using the basic RUS circuit (FIG. 1C) as a building block, rotation R_{y}(2q^{ok}(θ)) can be realized by recursively applying the basic construction (FIG. 2). The goal of using RUS is to realize a form of threshold behaviour on θ: if θ>π/4 then we would like the output qubit to be as close to R^{g}(π)|0 [symbol] =|1 [symbol] as possible and if θ<π/4 we would like the output qubit to be as close to R^{g}(0)|0 [symbol] as possible. Such threshold behaviour is an ingredient in realizing neural computation using quantum mechanics. Each iteration of RUS can be thought of as moving the input angle θ closer and closer to its attractor, which is 0 or π/2 depending on whether θ is greater than the threshold π/4. The closer θ is to the threshold, naturally more iterations are needed for bringing it close to its attractor. In order for an input angle θ which is at distance at most δ away from the threshold π/4, to get it to be at most E away from the attractor one needs

$$k = O ( log \frac{1}{δϵ} )$$

RUS iterations. The runtime of RUS circuits depends on the history of successes and failures at each measurement. On average, the circuit depth scales as O(14^{k}) for k iterations.

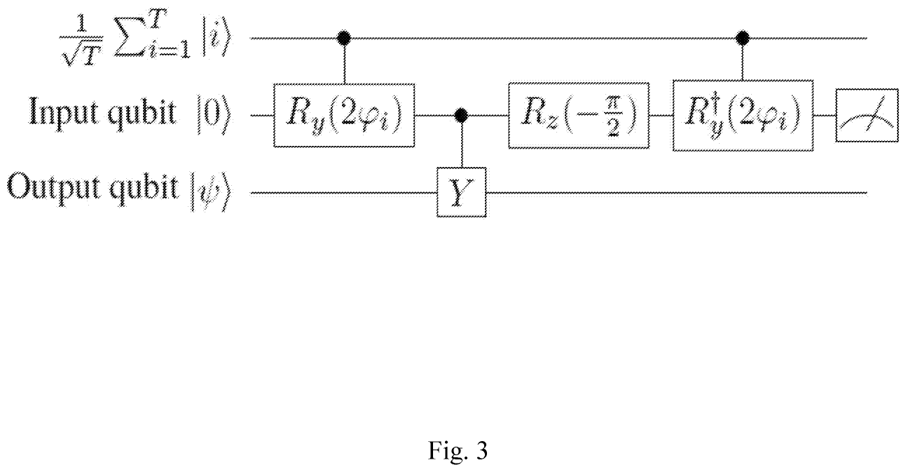

Referring to FIG. 3, a RUS is applied with a superposition of input rotations. Another feature of RUS circuits is that it can be applied in a quantum superposition. Consider the circuit in FIG. 3, where the input is controlled by a T-dimensional register. The controlled rotation onto the input qubit can be written as Σᵢ₌₁^{T}|1 [symbol] [symbol] 1|⊕R^{g}(φᵢ). With the control register initialized to a uniform superposition, conditioned on measurement outcome being 0, the final state is

$$\frac{1}{\sqrt{T}} {\sum }_{i = 1}^{T} {F}_{i} \vert i 〉 ⊗ \vert 0 〉 {R}_{y} ( q ( {ϕ}_{i} ) ) \vert ψ 〉 ,$$

which is also a superposition of rotated output states. Observe the factor Fᵢ, which deforms the original amplitudes of the superposition and depends on the angles φᵢ as well as the history of failures and successes in the execution of the repeat-until-success circuit (hence Fᵢ is a random variable).

The quantum neuron described herein can be used as building block for a wide variety of interesting quantum neural network models. Two exemplary applications are described below, the first one being feedforward networks. The template of this kind of networks may vary, from shallow ones demonstrated in this article to constructions similar to modern deep learning algorithms. The second application is the Hopfield network, which is a recurrent neural network that exhibits dynamical properties typical of associative memories and attractors. Being able to capture these properties is an important requirements of a genuine model of quantum neural networks.

Feedforward neural networks have been shown, both theoretically and empirically, to capture non-trivial patterns in data. Multiple copies of the quantum neuron described herein can be arranged to reproduce and generalize the behavior of traditional feedforward neural networks. Due to the coherent nature of the construction, training inputs can be processed in superposition, which enables handling larger training sets than what is typically tractable on classical computers.

Consider a classical feedforward neural network that serves as a binary function ƒ: {−1, 1}ⁿ [symbol] ^{{-1, 1}}^{m} that takes an input of n bits and returns a binary string of m bits. The input z∈{−1, 1}ⁿ is stored in the input layer of n neurons. Then the states of the input neurons are passed on to a hidden layer of neurons. The i-th hidden neuron will linearly combine the values of the input layer, forming a biased weighted input signal θᵢ=Σⱼw^{ij}xⱼ+bᵢ and the final state of the hidden neuron is computed by feeding the input through a step function σ(θᵢ) which evaluates to +1 if θᵢ>0 and −1 otherwise. The values of the hidden neurons may be passed to yet another layer of hidden neurons in the same fashion, until the final layer is reached. This final layer consists of m neurons that store the outputs of the neuron network. Each two adjacent layers of neurons are commonly connected as a complete bipartite graph.

Denote σ(y) as the vector obtained by applying a element-wise to the vector y. Consider a multi-layer perceptron with input layer z^{(θ)}=x and [symbol] hidden layers) z⁽¹⁾, . . . , [symbol] , [symbol] with [symbol] being the output layer. Let W^{(l)} be the weight matrix connecting the (i−1)-th layer to the i-th and b⁽ⁱ⁾ be the bias on the i-th layer, i=1, . . . , [symbol] . Then the neural network propagates the information according to the relationship

z⁽ⁱ⁾=σ(W⁽ⁱ⁾z⁽ⁱ⁻¹⁾+b⁽ⁱ⁾), i=1, . . . , [symbol] , Equation 1

and the overall function is denoted as [symbol] =ƒ(x). For a given set of training data {x₁, x₂, . . . , x_{T}} with the corresponding outputs y₁, y₂, . . . , y_{T}, the goal of training is to minimize the loss function over the training data:

$${min}_{W , b} {\sum }_{j = 1}^{T} {‖ {y}_{j} - f ( {x}_{j} ) ‖}_{2}^{2} . \qquad Equation 2$$

Here additional terms that may arise in practice such as regularization are ignored. Because the objective function as well as the parameters (weights and biases) are evaluated classically, these additional terms can be easily added as part of the classical computing for the objective function.

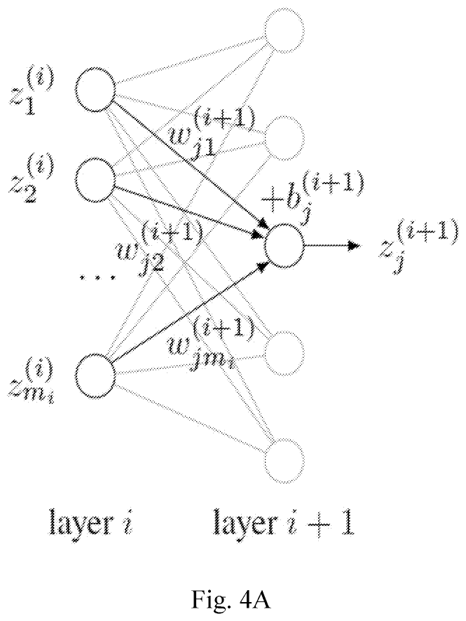

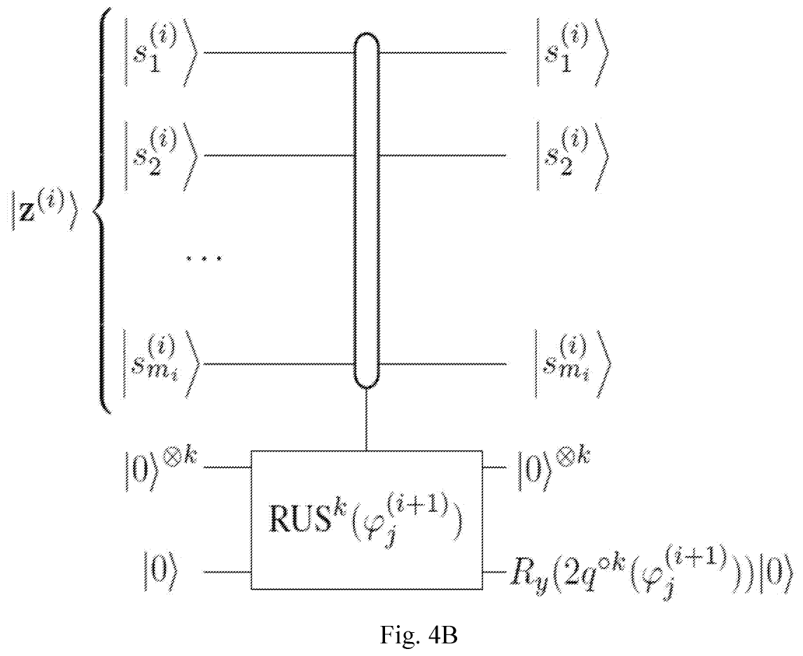

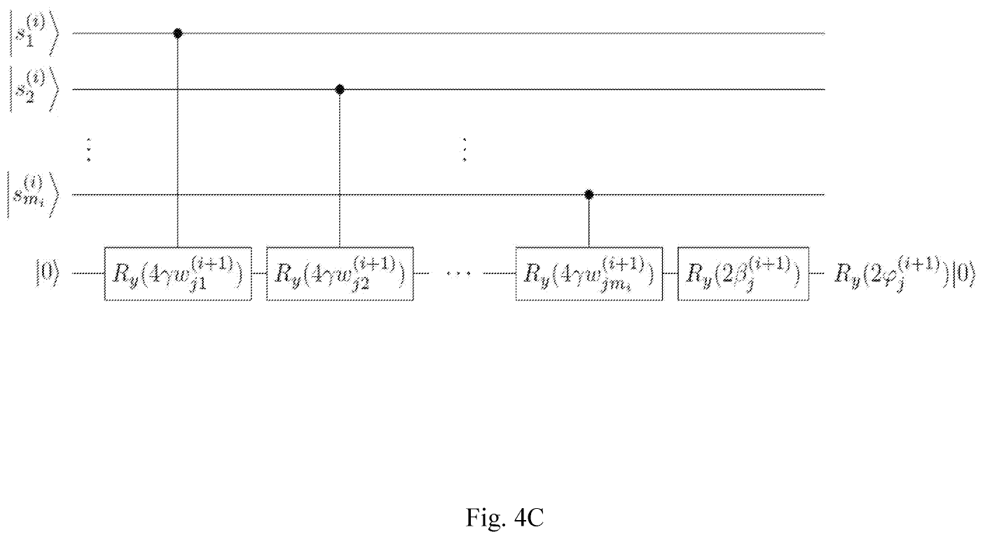

FIG. 4 illustrates the construction of a feedforward network of quantum neurons. FIG. 4A illustrates propagating the neural state of the previous layer to a neuron in the current layer of the classical neural network. FIG. 4B illustrates a quantum circuit realization of the quantum neuron propagation. Here the bottom qubit corresponds to neuron sⱼ⁽ⁱ⁺¹⁾. The k ancilla qubits can be recycled for the next neuron propagation. The block control for the RUS^{k} operation represents controlled rotations by angle φⱼ⁽ⁱ⁺¹⁾, as shown in detail in FIG. 4C as well as FIG. 2. FIG. 4C illustrates a circuit for applying rotation by the input angle φⱼ⁽ⁱ⁺¹⁾=γθⱼ⁽ⁱ⁺¹⁾+π/4, where θⱼ⁽ⁱ⁺¹⁾=Σₚ₌₁^{m}^{ₛ}wⱼₚ⁽ⁱ⁺¹⁾zₚ⁽ⁱ⁾+bⱼ⁽ⁱ⁺¹⁾ is the input signal, γ is a scaling factor to ensure that φⱼ⁽ⁱ⁺¹⁾∈|0, π/2] and βⱼ⁽ⁱ⁺¹⁾=π/4+γ(bⱼ⁽ⁱ⁺¹⁾−Σₚ₌₁^{m}^{ₜ}wⱼₚ⁽ⁱ⁺¹⁾) is an angular shift.

In the quantum setting, one qubit is introduced for each neuron in a classical feedforward neural network. k ancilla qubits are introduced for the RUS circuits. As shown in FIG. 4, the propagation from layer i to each individual neurons in i+1 is realized by a k iterations of RUS circuits where the state of the qubits corresponding to the previous layer serve as the control register for determining the input angle φⱼ⁽ⁱ⁺¹⁾ to the j-th qubit in the layer i+1. The RUS iterations realizes the threshold dynamics similar to the activation function in the case of classical neural networks. Broadly speaking, one could consider the quantum feedforward network a quantized version of a classical neural network where all of the neurons in the hidden layers of the classical network are replaced by quantum neurons. The properties of RUS circuits allow approximation of Equation 1 with a being a sigmoid function such as q^{ok}(φ).

One could use this quantum feedforward neural network for recovering classical feedforward neural networks. The precise connection is stated in the following theorem. Here a quantum algorithm is said to simulates a classical feedforward neural network if and only if it produces states |z⁽ⁱ⁾ [symbol] , i=0, . . . , [symbol] , from which one could efficiently obtain the corresponding state z⁽ⁱ⁾∈{−1, 1}^{m}^{ᵢ} of each layer i of the classical neural network.

Theorem 1 There is a quantum algorithm which simulates, with success probability at least 1−η and error at most ∈, an [symbol] -layer classical deep feedfomard neural network with layer size at most n, step function activation and weights/bias setting described in Equation 28, in time

$$O ( \frac{{n}^{3.075} 𝓁}{{δ}^{2.075} {ϵ}^{3.15}} log ( \frac{𝓁}{v} ) ) . \qquad Equation 3$$

The total number of qubits needed for the simulation is

$$O ( n 𝓁 + log \frac{n}{{δϵ}^{1.52}} ) . \qquad Equation 4$$

In the setting of the above theorem, it is assumed that the input state is a computational basis state |z⁽⁰⁾) that corresponds to some classical input. However, in general one could imagine having a superposition of training data as inputs (refer to Equation 2 for notation definition):

$$\frac{1}{\sqrt{T}} {\sum }_{j = 1}^{T} \vert {x}_{j} 〉 \vert {y}_{j} 〉 \qquad Equation 5$$

where the register holding |xⱼ [symbol] is the input layer of the quantum neural network and an ancilla qubit is introduced for holding the state |yⱼ [symbol] , which is the correct output for each of the training data xⱼ. No assumption is made concerning the method to efficiently generate the superposition of the states |xⱼ [symbol] |yⱼ [symbol] . It can be obtained from classical training examples by using a construction such as the QRAM, or may be the output of a quantum circuit, or simply provided by the owner of quantized databases. The information contained in the state described by Equation 5 is then propagated through the quantum neural network. The accuracy of training is quantified by averaging over the pairwise measurement of [symbol] on the output layer qubits in state [symbol] and the ancilla qubits with the state |yⱼ [symbol] . More precisely, suppose yⱼ has length m. Let a₁ through aₘ denote qubits in |z^{(l)} [symbol] and b₁ through bₘ denote qubits |yⱼ [symbol] . The training accuracy can be characterized by

$$\overline{〈 ZZ 〉} = \frac{1}{m} {\sum }_{j = 1}^{m} 〈 {Z}_{{a}_{j}} {Z}_{{b}_{j}} 〉 . \qquad Equation 6$$

The averaged expectation value [symbol] ranges between −1 and 1, with [symbol] =1 signifying perfect training. Hence the training problem is formulated as finding the assignment of weights and biases satisfying Equation 28 such that the [symbol] value is maximized. Alternatively, one might also consider generalizing the training accuracy as

$$\overline{〈 ZZ 〉} = {\prod }_{j = 1}^{m} 〈 {Z}_{{a}_{j}} {Z}_{{b}_{j}} 〉 . \qquad Equation 7$$

In this case [symbol] =1 still signifies perfect training. However, such training objective puts more stringent requirement on the classifier being able to produce high accuracy on all of the qubits.

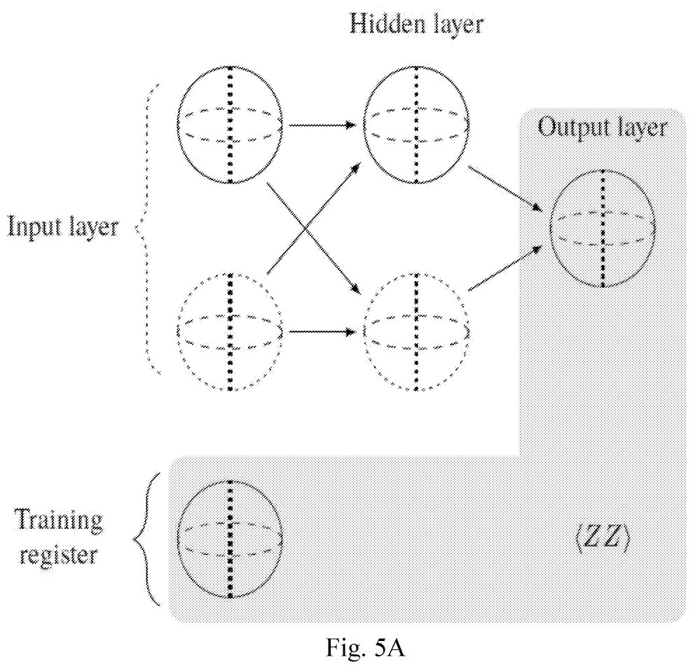

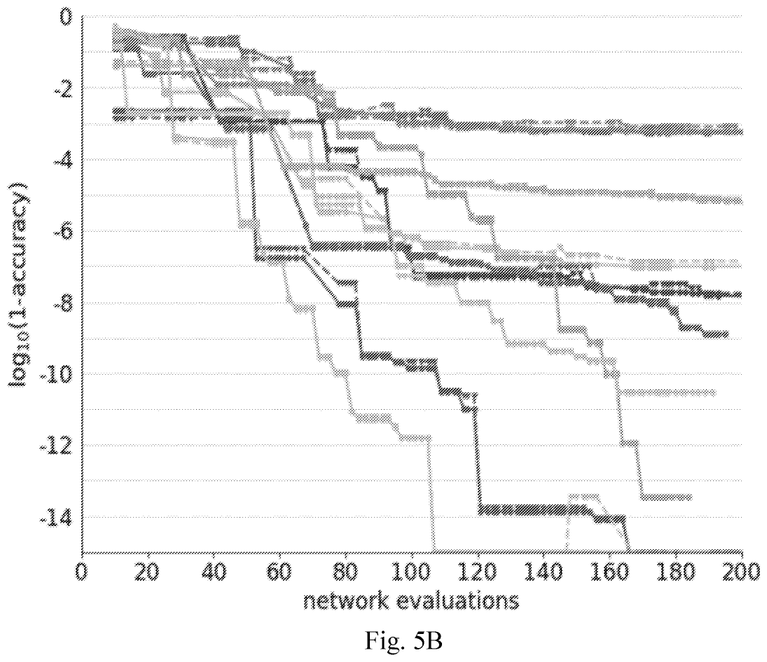

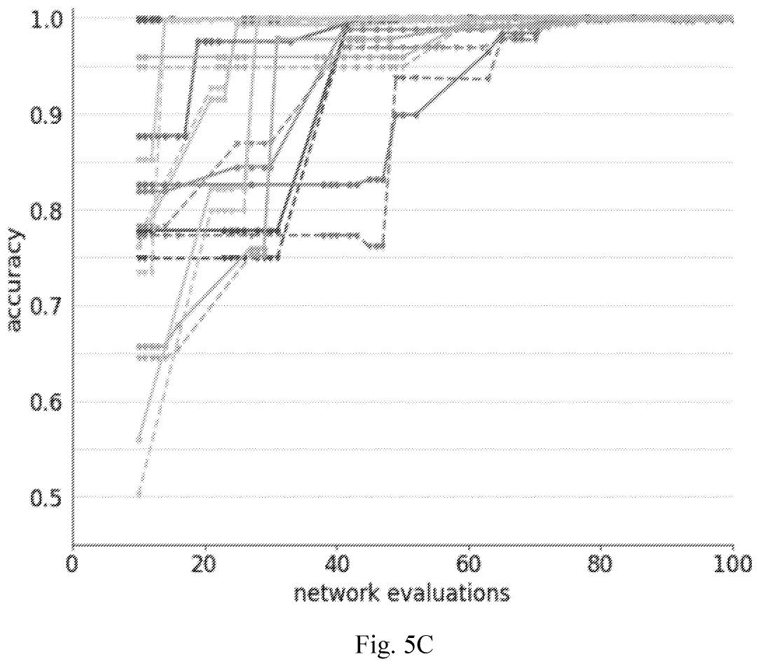

Referring to FIG. 5, training of a quantum neural network-for capturing the XOR function is illustrated. FIG. 5A is a schematic view of the XOR network. Here each sphere represents a qubit. Unlike in FIG. 1B, for simplicity the ancilla qubit is omitted in the arrow representations of the propagation of quantum state from one layer to the next. During training, the network is initialized in the state ½Σₓ_{₁}_{,x}_{₂}|x₁x₂ [symbol] |XOR(x₁,x₂) [symbol] for the joint system of the input layer and the training register, and |0 [symbol] on all the other qubits. The network is then propogated from the input layer to the output layer as in FIG. 4, and [symbol] [symbol] is measured between the output qubit and the training qubit.

FIG. 5B is a graph of results for optimizing the parameters (weights and biases) of the XOR network using Nelder-Mead algorithm. Here accuracy is defined as ((̅Z̅Z̅ [symbol] +1)/2 where (̅Z̅Z̅)̅ is defined in Equation 6. Train is on a superposition of training data, while testing in on individual computational basis states |x₁x₂ [symbol] |XOR(x₁x₂) [symbol] . The solid lines represent the training accuracy while the dashed lines represent the testing accuracy. Different colors represent optimization runs with different initial guesses.

Two examples are used to illustrate the design of a quantum neural network that implements a binary classifier. The first example is the XOR function, where the goal is to train a neural network as a binary classifier to compute the function XOR(x₁, x₂)=x₁⊕x₂ for any given input (x₁, x₂)∈{0, 1}². The XOR problem is important because it was one of the first problems identified as an example of the limitations of the common artificial neuron construction, since a single neuron, or a single layer of neurons, cannot capture the linearly inseparable XOR function. However, by constructing a multi-layer neural network such as the 2-2-1 network (FIG. 5A), one could train the network to learn the XOR function. During the training the weights and biases are iteratively varied to maximize [symbol] Z̅Z̅ [symbol] between the output qubit and the training qubit, and test the current parameter setting by initializing the input and training registers at individual |x_{g} [symbol] |yⱼ [symbol] states (Equation 5 and evaluate [symbol] [symbol] . The accuracy values ( [symbol] Z̅Z̅ [symbol] +1)/2 obtained from training and testing are defined as the training accuracy and testing accuracy respectively.

Numerical results (FIG. 5B) show that the network can be trained to almost perfect training and testing accuracy. The training process is based on only copies of a single state of the form in (Equation 5), while the testing is performed on each input state |x₁ [symbol] |yⱼ [symbol] separately. This demonstrate a form of learning that is fundamentally different from the classical neural networks, where training data are fed sequentially into the training as mini-batches. The numerical results provide evidence that it suffices to train the quantum neural network on a single state that is a superposition of training data.

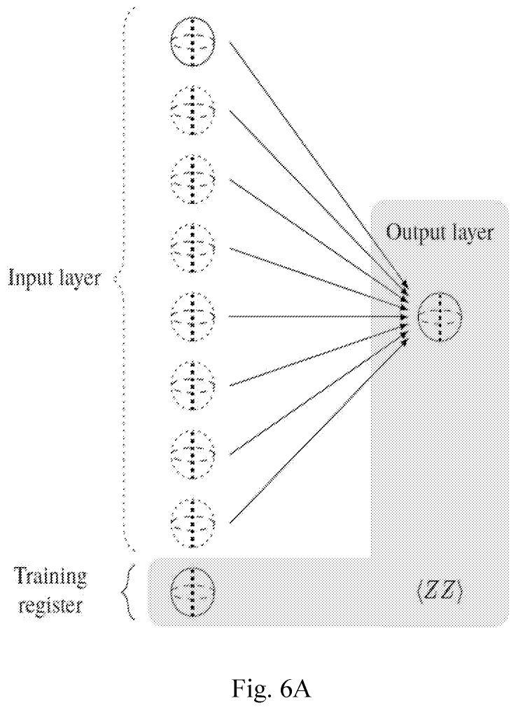

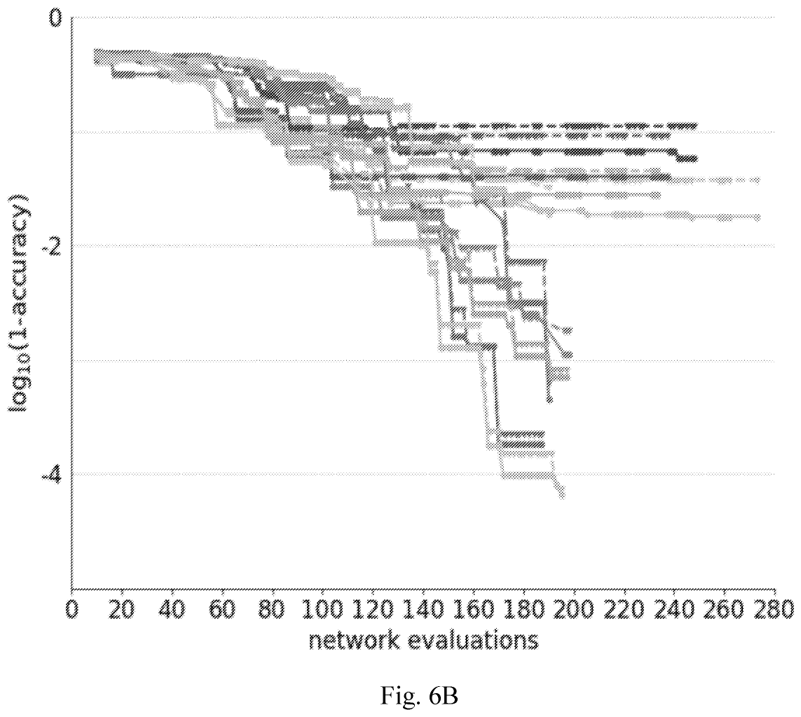

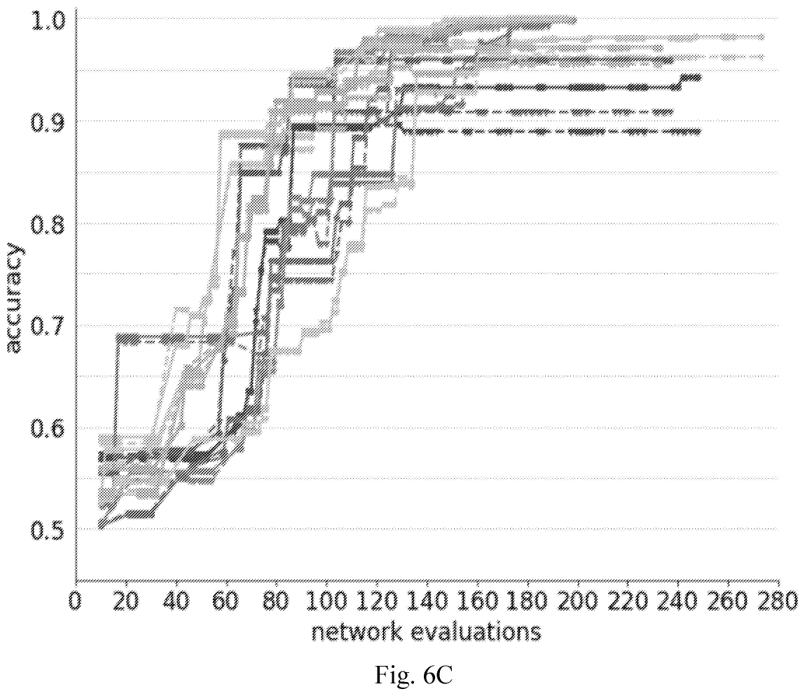

Referring to FIG. 6, training of a quantum neural network for capturing the parity function is illustrated. FIG. 6A is a schematic of the parity network. Here, each sphere represents a qubit. Unlike FIG. 1B, for simplicity the ancilla qubit is omitted in the arrow representations of the propagation of quantum state from one layer to the next. During training, the network is initialized in the state 1/16Σₓ_{₁}_{, . . . ,x}_{₈}|x₁ . . . x₈ [symbol] |Parity(x₁, . . . x₈) [symbol] for the joint system of the input layer and the training register, and |0 [symbol] on all the other qubits. The network is then propagated from the input layer to the output layer as in FIG. 4, and [symbol] [symbol] is measured between the output qubit and the training qubit. FIG. 6B is a graph of results for optimizing the parameters (weights and biases) of the parity network using the Nelder-Mead algorithm. Here accuracy is defined as ( [symbol] [symbol] +1)/2 where [symbol] [symbol] is defined in Equation 6. Training is on a superposition of training data but testing is on individual computational basis states |x₁ . . . x₈ [symbol] |Parity(x₁, . . . x₈) [symbol] . The solid lines represent the training accuracy while the dashed lines represent the testing accuracy. Different colors represent optimization runs with different initial guesses.

To add to the numerical evidence, a second example is provided, which is an 8-1 parity network. A schematic of the network is shown in FIG. 6a. The goal is to train the network to learn an 8-bit parity function Parity(x₁, . . . x₈)=x₁⊕ . . . ⊕x₈. The numerical results are shown in FIG. 6B, which shows that for some initial guesses of the weights, the network can be trained to perfect accuracy. Unlike the XOR network, which has a hidden layer, here the parity network does not have any hidden layer while it is still able to learn the parity function. This is because the training does not impose restriction on the range of weights and biases in the setting of Theorem 1. This enables the training to take advantage of the periodicity of the function q(θ), since unrestricted weights and biases may put θ outside the interval [0, π/2], where the function q(θ) is not strictly monotonic.

In the classical setting, a Hopfield network starts with an initial state (z₁, z₂, . . . , zₙ) which can be considered as the input state. The state of each neuron zᵢ∈{−1, 1} is a classical bit. Then the network undergoes a sequence of updates. During each update, a random neuron j is selected and its new state is assigned to be 1 if Σ_{i≠j} wᵢzᵢ>hⱼ for some threshold hⱼ associated with the j-th neuron and the new state is assigned to be −1 otherwise. As the updates proceed, the state of the network converges to a state that is a local minimum of the energy function E=½Σ_{i,j} wᵢⱼzᵢzⱼ+Σᵢ^{h}^{ᵢ}^{z}^{ᵢ}. Such local minima are attractors of the network and any input state that is reasonably close to a local minimum will converge to the minimum after sufficiently many updates. It is such attractor dynamics that gives a Hopfield network the property of an associative memory.

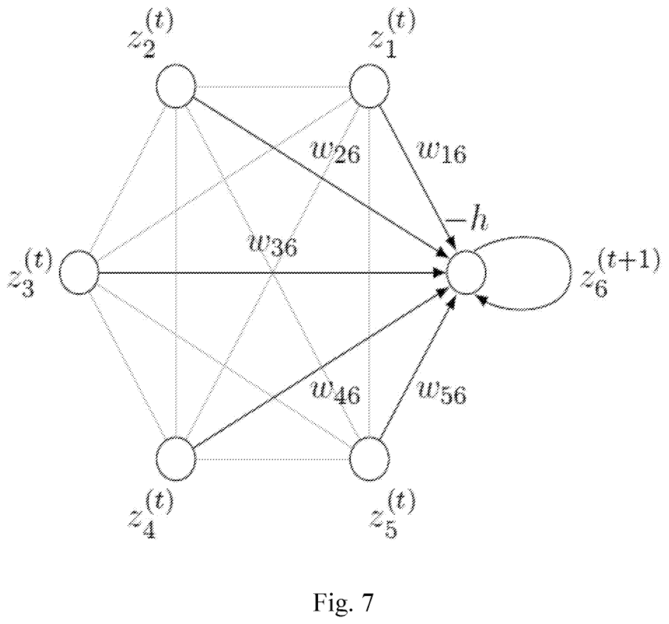

In the quantum setting, n qubits are introduced, one for each neuron in the classical Hopfield net. Assume the n qubits are in a computational basis state corresponding to the state of the classical Hopfield net before the update. To realize the threshold dynamics of the update step, k ancilla qubits are introduced for the iterative repeat-until-success circuits (FIG. 2B). For the j-th update, suppose neuron iⱼ∈|n] is chosen. Then the joint state of the remaining qubits [n]\{iⱼ} is used as the input state |φ [symbol] for the RUS circuit (FIG. 2), which produces an output qubit that is close to the state |0 [symbol] if the total weight Σ_{j≠i}_{₁} wⱼᵢ_{₁} zⱼ<hᵢ_{₁} and |1 [symbol] otherwise. The detailed circuit for realizing such transformation is similar to the ones in FIG. 4, with minor modifications of the bias replaced with minus the threshold (FIG. 7). The output qubit of the RUS circuit is called the new neuron iⱼ and its state is used for the next updates. In general, let bᵢ^{(j-1)}∈{0, 1} be the state of neuron i∈[n] at the (j−1)-st update: bᵢ^{(j-1)}=0 iff zₜ^{(j-1)}=−1 and bᵢ^{(j-1}=−1 iffzᵢ^{(j-1)}=1.

Then suppose neuron iⱼ is chosen for the j-th update. The joint state of qubits corresponding to the latest state of neurons n\{iⱼ} is used as the input state for the RUS circuits, producing a new qubit in state |ᵢ_{ⱼ}^{(j)}). After a sequence oft updates, the state is of the form

|b₁⁽⁰⁾ . . . bₙ⁽⁰⁾bᵢ_{₁}⁽¹⁾bᵢ_{₂}⁽²⁾ . . . bᵢ_{ₜ}^{(t)} [symbol] Equation 8

where bᵢ_{ₖ}^{(k)} is the state of neuron iₖ. The state above records a history of how the state has evolved over the updates. If at the (t+1)-st update, the neuron iᵢ₊₁ is chosen, then a new qubit is introduced in |0 [symbol] state and the k-iteration RUS (FIG. 2B) is applied using the state of the set of qubits representing the latest state of the remaining neurons [n]\{iᵢ₊₁} as the control state |φ [symbol] .

The behaviour of classical Hopfield network can also be easily recovered from this quantum model. For simulating classical Hopfield network, the number of qubits need not grow linearly as the number of updates. Suppose at some iteration k, the neuron iₖ is chosen for update. The RUS iterations are applied as before to prepare an output state which is close to either |0 [symbol] or |1 [symbol] depending on the states of the neurons (qubits) [n]\{iₖ}. The output qubit may be measured, and the RUS propagation and output qubit measurement repeated several times. A majority vote on the measurement outcomes should give the correct state with high probability. The qubit iₖ can then be prepared in the n qubits for the Hopfield network in the same state as the output qubit.

Referring to FIG. 7, a schematic of a Hopfield network update step is provided. Here at step t, the neuron 6 is chosen for update. The new state z₀^{(t+1)}=σ(w₁z₁^{(t)}+ . . . +w z_{g}^{(t)}−h) where σ is a step function such that σ(x)=1 if x>0 and −1 if x<0. Note the minus sign before h because in this case h is the threshold rather than the bias, unlike feedforward networks.

A precise statement regarding the connection between the Hopfield network of quantum neurons and the classical Hopfield network is the following theorem below. A network of quantum neuron is said to simulate t updates of a Hopfield network of n neurons if and only if for a sequence of intermediate states z₍₀₎, z⁽¹⁾, . . . , z^{(t)} of the Hopfield network, the quantum system also goes through a sequence of states |z⁽⁰⁾ [symbol] , |z⁽¹⁾ [symbol] , . . . , |z^{(t)} [symbol] with each |z^{(t)} [symbol] such that using it one could efficiently compute z⁽ⁱ⁾.

Theorem 2 There is a quantum algorithm that simulates t updates of an n-neuron Hopfield network with weights and biases satisfying Equation 28, up to error ∈ and success probability at least 1−v, in expected runtime

$$O ( \frac{{n}^{2.075} t}{{δ}^{2.075} {ϵ}^{3.15}} log ( \frac{t}{v} ) ) . \qquad Equation 9$$

The total number of qubits needed for the simulation is

$$O ( n + log \frac{n}{{δϵ}^{1.52}} ) . \qquad Equation 10$$

In the classical case the time and qubit costs are O(nt) and n respectively. Hence the Hopfield network of quantum neurons simulates the classical Hopfield work with a roughly linear (in n) overhead in time and logarithmic (in n) overhead in memory. However, beyond the classical setting, the Hopfield network of quantum neurons is also capable of behaviors that are possible on any classical computational devices.

Although feedforward networks and Hopfield networks of quantum neurons have been shown as two examples, the variety of possible networks constructed using the quantum neuron by no means are restricted to these two. For example, one could use quantum neurons to construct autoencoders. In this case, the construction of deep feedforward network is used, but with input and output layers consisting of equal number of qubits. In training the network, instead of preparing the state in (Equation 5), one prepares the input layer of qubits in whichever state that is to be compressed and measure the quality of the autoencoder by making correlated [symbol] ZZ [symbol] measurements between pairs of qubits in the input and output layers (instead of the training register and output layers as is the case for feedforward network).

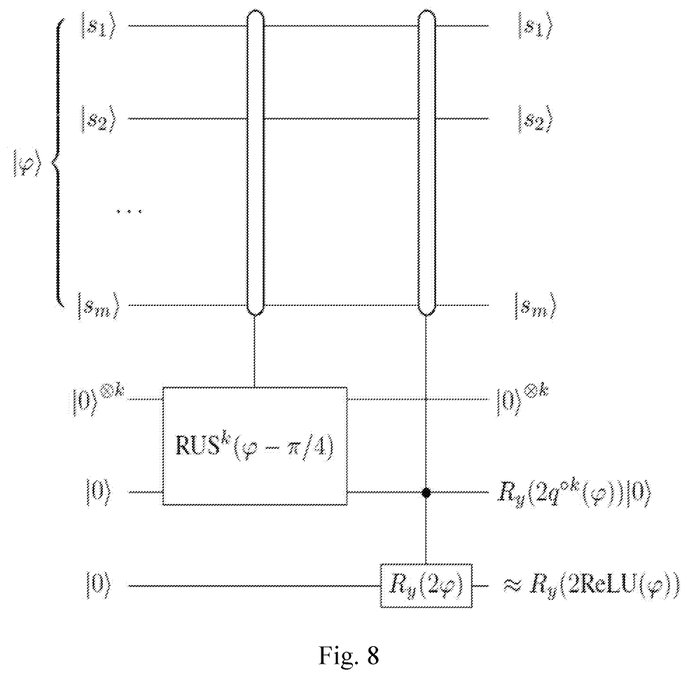

Referring to FIG. 8, a schematic view of a circuit for approximating ReLU activation is provided. Another application of the disclosed quantum neuron is to approximately realize Rectified Linear Unit (ReLU) activation using the circuit in FIG. 8. Here, the circuit in FIG. 4B is used for producing a qubit that is close to |1 [symbol] only when φ>0. This bit is then used as a control qubit, together with the input register encoding |φ [symbol] , for realizing a controlled rotation by angle φ on the output qubit (bottom qubit in FIG. 8).

A convergence analysis of the nonlinear map q is provided below.

Here we analyze in detail the nonlinear map φᵢ₊₁=q(φᵢ)=arctan² φᵢ to find the minimum number of RUS iterations needed for yielding a final φᵢ value that differs from its attractor by at most ∈. Suppose φ₀>π/4. Let Δᵢ=φᵢ−π/4 and Ωᵢ=π/2−φ₈. Then for π/4<φ<3π/8, we have

Δᵢ₊₁≥(λ/8)⁻¹ arctan tan²(π/8+π/4)Δᵢ=αΔᵢ Equation 11

where α≈3.5673. For 3π/8<φⁱ<π/2, we have

Ωᵢ₊₁≤(π/8)⁻¹(π/2−arctan tan²(π/8+π/4))Ωᵢ=βΩᵢ Equation 12

where β≈0.4327. Let k₁ be the number of RUS iterations needed for Ωᵢ to reach 3π/8. Then k₁≥log_{α}(3π8Δ₀). Let k₂ be the number of RUS iterations needed for Ωᵢ to be ϵ—close to π/2, which is the attractor for the case φ₀>π/4 being considered. Then k₂≥log_{1/β}(1/ϵ). Hence the total number of iterations

$$k = ⌈ {log}_{α} ( \frac{3 π}{8 {Δ}_{0}} ) ⌉ + ⌈ {log}_{1 \text{/} β} ( \frac{1}{ϵ} ) ⌉ \qquad Equation 13$$

can ensure that |φₖ−π/2|≤ϵ. Because of symmetry the same expression for k can be derived for the case φ₀<π/4.

A runtime analysis of RUS circuits is provided below.

Consider the RUS circuit in FIG. 1C. A simple calculation shows that the probability of measuring |0 [symbol] is p(θ)=sin⁴ θ+cos⁴ θ and the probability of measuring |1 [symbol] is 1−p(θ). Hence, the expected runtime of the circuit is 1/p(θ)≤2. Fork iterations of RUS circuits, there are in total k different levels of recursions, with the bottom recursion consisting of circuits of FIG. 1C. Let tⱼ be the total time spent running j iterations of the RUS circuit (For example in FIG. 2, j=2). Then the expectation values are

$$𝔼 ( {t}_{1} ) = \frac{1}{p ( θ )} \leq 2 \\ 𝔼 ( {t}_{k} ) = \frac{1}{p ( {q}^{ok} ( θ ) )} \cdot 𝔼 ( {t}_{k - 1} ) \cdot 2 = {( {\prod }_{{k}^{′} = 0}^{k} p ( {q}^{{ok}^{′}} ( θ ) ) )}^{- 1} \cdot {2}^{k + 1} \leq {2}^{2 k + 1} . \qquad Equation 14$$

Now consider RUS iterations with the base recursion consisting of the circuit in FIG. 3 with the control register being in a general superposition Σᵢ₌₁^{T} αᵢ|i [symbol] . For a single iteration (FIG. 3), the state of the system before measure is

$${\sum }_{i = 1}^{T} {α}_{i} \vert i 〉 ⊗ [ \sqrt{p ( {ϕ}_{i} )} \vert 0 〉 {R}_{y} ( q ( {ϕ}_{i} ) ) \vert 0 〉 + \sqrt{1 - p ( {ϕ}_{i} )} \vert 1 〉 {R}_{y} ( π \text{/} 4 ) \vert 0 〉 ] . \qquad Equation 15$$

The probability of measuring |0 [symbol] at this stage is P=Σᵢ₌₁^{T}|αᵢ|²p(φᵢ), yielding a state

$${\sum }_{i = 1}^{T} {α}_{i} \sqrt{\frac{p ( {ϕ}_{i} )}{P}} \vert i 〉 \vert 0 〉 {R}_{y} ( q ( {ϕ}_{i} ) ) \vert 0 〉 . \qquad Equation 16$$

The probability of measuring |1 [symbol] is P^{⊥}=Σᵢ₌₁^{T}|αᵢ|²(1−p(φᵢ)), yielding a state

$${\sum }_{i = 1}^{T} {α}_{i} \sqrt{\frac{1 - p ( {ϕ}_{i} )}{{P}^{⊥}}} \vert i 〉 \vert 1 〉 {R}_{y} ( π \text{/} 4 ) \vert 0 〉 . \qquad Equation 17$$

In general if RUS fails r−1 times and succeeds (namely measuring |0 [symbol] ) at the r-th trial, the state is

$${\sum }_{i = 1}^{T} {α}_{i} \sqrt{\frac{{( 1 - p ( {ϕ}_{i} ) )}^{r - 1} p ( {ϕ}_{i} )}{{P}_{r}}} \vert i 〉 \vert 0 〉 {R}_{y} ( q ( {ϕ}_{i} ) ) \vert 0 〉 \qquad Equation 18$$

where PᵣΣᵢ₌₁^{T}|αᵢ|²(1−p(φᵢ))^{r-1}p(φᵢ) is the normalization factor for the state corresponding to success at trial r. Accordingly Pᵣ^{⊥}=Σᵢ₌₁^{T}|αᵢ|²(1−p(φᵢ))^{r} is defined as the normalization factor for the state produced at failure of the trial r. A simple calculation can show that at the r-th trial, for r>1 the probability of success is Pᵣ/Pᵣ₋₁^{⊥} and the probability of failure is Pᵣ^{⊥}/P^{r-1}^{⊥} Hence the expected number of trials needed is

$$𝔼 ( t ) = {P}_{1} + {\sum }_{r = 2}^{∞} r \frac{{P}_{r}}{{P}_{1}^{⊥}} \leq 1 + {\sum }_{r = 2}^{∞} {r ( \frac{1}{2} )}^{r - 2} = 7. \qquad Equation 19$$

The inequalities Pᵣ≤Σᵢ₌₁^{T}|αᵢ|²(1−p(φᵢ))(½)^{r-2}=P₁^{⊥}(½)^{r=2} and ½≤p(φ)≤1 are used.

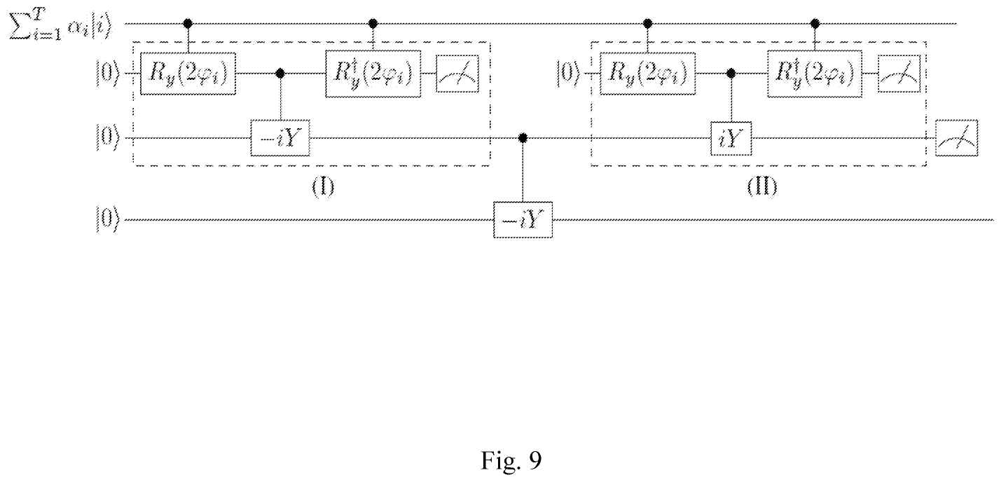

FIG. 9 is a schematic view of a circuit comprises two iterations of RUS with an input controlled by a T-dimensional register in even superposition. Consider the second round of RUS circuit with the input qubit reset to |0 [symbol] after the measurement step (circuit (II) in FIG. 9). Suppose the subroutine (I) underwent r trials, producing a state in Equation 18. Let α₁^{t}=αᵢ{square root over ((1−p(φᵢ))^{r-1}p(φₛ)/P^{r})}. Then the probability analysis for circuit (II) is analogous to that for circuit (I). The state after s trials with the last trial being the only success can be written as

$${\sum }_{i = 1}^{T} {α}_{i}^{′} \sqrt{\frac{{( 1 - p ( {ϕ}_{i} ) )}^{s - 1} p ( {ϕ}_{i} )}{{P}_{s}^{′}}} \vert i 〉 [ \sqrt{p ( q ( {ϕ}_{i} ) )} \vert 0 〉 {R}_{y} ( q ( q ( {ϕ}_{i} ) ) ) \vert 0 〉 + \sqrt{1 - p ( q ( {ϕ}_{i} ) )} \vert 1 〉 {R}_{y} ( π \text{/} 4 ) \vert 0 〉 ] \qquad Equation 20$$

where P′ₛ=Σᵢ₌₁^{T}|α′ᵢ|²(1−p(φᵢ))^{s-1}p(φᵢ). In principle it should be written p(−φₛ) and q(−φᵢ) instead of p(φᵢ) and q(φₛ). However, since p(φ)=p(−φ) and q(φ)=q(−φ) for any φ, φᵢ is used instead.

Define Pₛ^{⊥}=Σᵢ₌₁^{T}|α′ⱼ|²(1−p(φᵢ))⁸. Then the expected number of trials needed for (II) is

$$𝔼 ( {t}_{II} ) = {P}_{1}^{′} + {\sum }_{s = 2}^{∞} s \frac{{P}_{s}^{′}}{{P}_{s}^{′ ⊥}} \leq 7 \qquad Equation 21$$

by the same arguments leading up to Equation 19. The reason for the similarity between

Equation 19 and Equation 21 is that the arguments leading up to Equation 19 is independent of {αᵢ}. Therefore no matter whether it is {αᵢ} or {α′ᵢ}, essentially every RUS iteration of every level has expected number of trials bounded from above by 7. The expected number of bottom recursion trials in k iterations of RUS can then be bounded from above as

[symbol]

(tₖ)≤7· [symbol] (tₖ₋₁)·2≤ . . . ≤14^{k-1} [symbol] (t₁)≤½·14^{k}. Equation 22

One could also compute the amplitudes for the state of the system in FIG. 9 after the bottom qubit is measured. Let αᵢⁿ=α′ₖ{square root over ((1−p(φᵢ))^{s-1}p(φᵢ)/P′ₛ)}. Suppose the bottom qubit is measured |1 [symbol] and corrected for w consecutive trials, and during each trial i, rᵢ and sᵢ trials were needed for circuit (I) and (II) respectively. Let \vec{r}=(r₁, r₂, . . . , r_{w}) and \vec{s}=(s₁, s₂, . . . , s_{w}). Then at the (w+1)-st trial the state of the system can be written as

$${\sum }_{i = 1}^{T} {α}_{i}^{″} \sqrt{\frac{F ( {ϕ}_{i} ; \vec{r} , \vec{s} )}{{P}_{w}^{″}}} \vert i 〉 [ \sqrt{p ( q ( {ϕ}_{i} ) )} \vert 0 〉 {R}_{y} ( q ( q ( {ϕ}_{i} ) ) ) \vert 0 〉 + \sqrt{1 - p ( q ( {ϕ}_{i} ) )} \vert 1 〉 {R}_{y} ( π \text{/} 4 ) \vert 0 〉 ] \qquad Equation 23$$

where P″_{w}=Σᵢ₌₁^{T}|α″ᵢ|²F(φᵢ; \vec{r}, \vec{s}) is the normalization factor and the function F is dependent on the history of measurement outcomes at the end of circuits for each iteration of the RUS scheme, as stored in the vectors \vec{r} and \vec{s}:

$$F ( ϕ ; \vec{r} , \vec{s} ) = {\prod }_{i = 1}^{w} [ \underbrace{{( 1 - p ( ϕ ) )}^{{r}_{i} - 1} p ( ϕ )}_{( I )} \underbrace{{( 1 - p ( ϕ ) )}^{{s}_{i} - 1} p ( ϕ )}_{( II )} ( 1 - p ( q ( ϕ ) ) ) ] . \qquad Equation 24$$

For k iterations of RUS circuits (for instance the circuit in FIG. 9 has k=2), a new function Fₖ(φ; \vec{y}, \vec{n}) is defined where \vec{y} and \vec{n} are k-dimensional vectors. Each yᵢ is the total number of successes (measurement outcome |0 [symbol] ) at the i-th level of RUS and each nᵢ is the total number of failures (measurement |1 [symbol] ) at the i-th level. As an example, the function F in Equation 24 satisfies

$${F}_{2} ( ϕ ; \vec{y} = ( 2 , 0 ) , \vec{n} = ( {\sum }_{i = 1}^{w} ( {r}_{i} + {s}_{i} - 2 ) , w ) ) = F ( ϕ ; \vec{r} , \vec{s} ) . \qquad Equation 25$$

Fₖ(φ; \vec{y}, \vec{n}) is then defined as

$${F}_{k} ( ϕ ; \vec{y} , \vec{n} ) = {\prod }_{i = 1}^{n} {( 1 - p ( {q}^{oi} ( ϕ ) ) )}^{{n}_{i}} {p ( {q}^{oi} ( ϕ ) )}^{{y}_{i}} . \qquad Equation 26$$

for a particular run of k-iteration RUS circuit with superposition of inputs as in FIG. 9 for k=2. If the circuit successfully applies k iterations, the final state of the system is

$${{\sum }_{i = 1}^{T} {α}_{i} \sqrt{\frac{{F}_{k} ( {ϕ}_{i} ; \vec{y} , \vec{n} )}{P}} \vert i 〉 \vert 0 〉}^{⊗ k} {R}_{y} ( {q}^{ok} ( {ϕ}_{i} ) ) \vert 0 〉 \qquad Equation 27$$

where P=Σᵢ₌₁^{T}|αᵢ|²Fₖ(φᵢ; \vec{y}, \vec{n}) is the normalization factor. The vector \vec{y} is a k-dimensional vector such that yᵢ=2^{k-i} and \vec{n} is a vector of non-negative integers corresponding to the failure record of the particular run.

The weights and bias settings are discussed below.

As can be seen from Equation 13, the closeness of the initial angle φ₀ to the threshold π/4, as measured by Δ₀, determines how many RUS iterations are needed for the final state to be at most ∈ away from the respective attractor. Therefore if Δ₀ is allowed to be arbitrarily small, the number of RUS iterations is unbounded. To prevent this situation, a restriction is imposed to neural networks where the weights and bias values can be represented in resolution δ, namely

w=k_{w}δ,b=k_{b}δ+δ/2 Equation 28

for kw, k_{b}∈ [symbol] . The extra δ/2 term in the bias is intended such that for any n, xᵢ∈{−1, 1} with i∈[n], |w₁x₁+ . . . +wₙxₙ+b|≤δ/2.

Another issue in simulating classical feedforward neural network with the quantum setup described herein is that the activation value θ=w₁x₁+ . . . +wₙxₙ+b may also be unbounded from above, while it is preferable that the input φᵢ be restricted to [0, π/2). Let wₘₐₓ and bₘₐₓ be the maximum possible values of |w| and |b| respectively. For each time the state of the current layer (which consists of n qubits) is used for updating the state of the next layer, a scaling parameter is introduced

$$γ = 0.7 \cdot \frac{1}{{w}_{max} n + {b}_{max}} \qquad Equation 29$$

on the activation value such that the input rotation angle φ to the neuron in the next year is contained in [0, π/2).

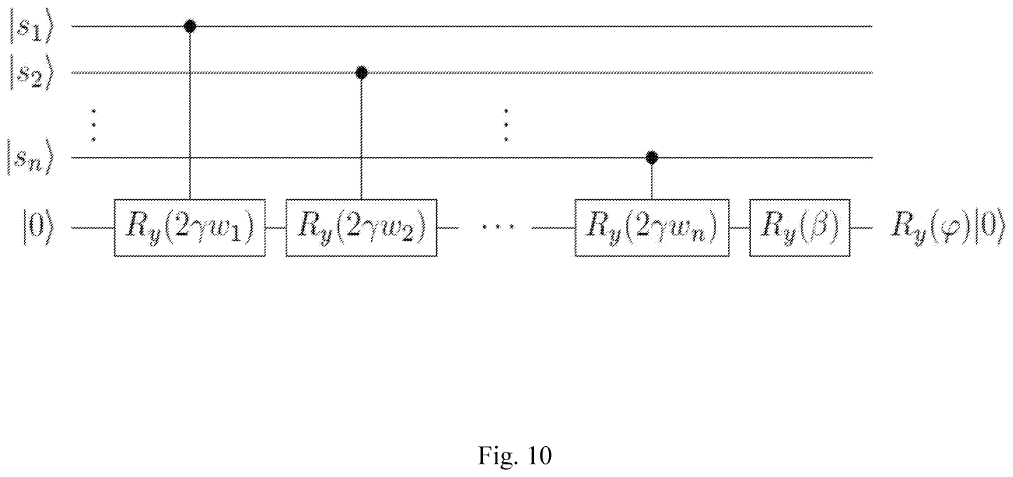

A final subtlety is the difference between the classical variables xᵢ taking values from {−1, 1} and corresponding qubits in state |sᵢ [symbol] with sᵢ∈{0, 1}. This can be addressed by the transformation xᵢ=2sᵢ−1. Putting these all together, the circuit in FIG. 10 results for applying a rotation by angle φ=γ(w₁x₁+ . . . +wₙxₙ+b)+π/4 to a qubit representing a neuron in the next layer. Hence in the feed-forward neural network of quantum neuron, the value of φ>π/4 iffθ>0 and φ<π/4 iffθ<0. Also γδ/2≤|φ−π/4|≤0.7<π/4, ensuring that φ is always restricted to [0, π/2).

Referring to FIG. 10, a quantum circuit is illustrated for simulating weighted and biased input process of the classical neural network in FIG. 1A. Here the bias β=π/4+γ(b−w₁− . . . −wₙ). The states |sᵢ [symbol] with sᵢ∈{0, 1} describe classical state of the neurons xᵢ∈{−1, 1} in the previous layer correspondingly.

Feedforward networks of quantum neurons are further described below.

Following the definitions used in Equation 1, let |z̅⁽ⁱ⁾ [symbol] denote the state of quantum neurons corresponding to the i-th layer z⁽ⁱ⁾ of the classical feedforward network, i=0, 1, . . . , [symbol] . Let |x⁽ⁱ⁾ [symbol] denote a computational basis state where each qubit is |0 [symbol] if the corresponding bit of z⁽ⁱ⁾ is in state −1 and |1 [symbol] if the corresponding neuron of z⁽ⁱ⁾ is in state 1.

Suppose |z̅⁽⁰⁾ [symbol] =|z⁽⁰⁾ [symbol] . Assume further that the weights in W⁽ⁱ⁾ and biases in b⁽ⁱ⁾ also satisfy the form described in Equation 28. Then using Equation 13 with Δ=γδ/2 and γ as in Equation 29, it suffices to have the number of RUS iterations as

$$\tilde{k} = ⌈ {log}_{α} ( \frac{3 π}{4 δ} \cdot \frac{1}{0.7} ( {nw}_{max} + {b}_{max} ) ) ⌉ + ⌈ {log}_{1 \text{/} β} ( 1 \text{/} ϵ ) ⌉ ∈ O ( log \frac{n}{{δϵ}^{1.52}} ) \qquad Equation 30$$

to ensure that the following holds for any weighted input θ from z⁽⁰⁾ and φ=γθ+π/4

|q^{o\tilde{k}}(φ)−g(θ)|≤ϵ. Equation 31

Substituting the expression for k̅ into the bound for expected runtime in Equation 22 yields a runtime of

O(14^{\tilde{k}})=O((n/δ^{log}^{_{α}}¹⁴(1/ϵ)^{log}^{_{1/β}}¹⁴)=O((n/δ)^{2.075}(1/ϵ)^{3.15}) Equation 32

for each application of k-iteration RUS circuit with the previous layer z⁽⁰⁾ of n qubits (bits). Suppose the layer z⁽¹⁾ (resp. |\tilde{z}⁽¹⁾ [symbol] ) has m neurons (resp. qubits), then the total runtime is O(n^{2.0075}m) for propagating from layer z⁽⁰⁾ to layer z⁽¹⁾.

Note that k̅ is a function of the number of neurons n in the previous layer. Consider a network in which to propagate from layer z⁽ⁱ⁾ to layer z⁽ⁱ⁺¹⁾, the number of RUS iterations is used according to Equation 30. Error accumulates as more and more layers are introduced into the network.

Because of Equation 31, in |z⁽¹⁾ [symbol] each qubit has a rotation angle that is at most ϵ away from the state of its counterpart in the classical feedforward network. For example, if in the classical network z⁽¹⁾=010 then the state |z⁽¹⁾ [symbol] has at least as much overlap with |010 [symbol] as the state

(cos ϵ|0 [symbol] +sin ϵ|1 [symbol] )⊗(cos(π/2−ϵ)|0 [symbol] +sin(π/2−ϵ)|1 [symbol] )⊗(cos ϵ|0 [symbol] +sin ϵ|1 [symbol] ). Equation 33

The amplitude of the state |010 [symbol] is 1−3ϵ²/2+O(ϵ⁴), while the amplitudes of the other states |s [symbol] is O(ϵ^{h(s,010)}) with h(x, y) being the Hamming distance between two bit strings x and y. When propagating from layer |\tilde{z}⁽¹⁾ [symbol] to |\tilde{z}⁽²⁾ [symbol] , the input state to the RUS circuit is a superposition (with amplitudes concentrated on the computational basis state |x₍₁₎ [symbol] ). This leads to further complications when propagating from |\tilde{z}⁽²⁾ [symbol] to |\tilde{z}⁽³⁾ [symbol] and it is in general unclear whether amplitudes will remain concentrated on the states that correspond to classical neural networks. One way to deal with such complication is to make a measurement on the current layer after the propagation from the previous layer. Then the previous layer is always in a computational basis state and if the previous layer corresponds to the correct state that matches with the classical neural network, amplitude will always be concentrated on the correct state in the current layer.

Suppose one is propagating from the (j−1)-st layer to the j-th layer and |\tilde{z}^{(j-1)} [symbol] =|z^{(j-1)} [symbol] . Then if |\tilde{z}^{(j)} [symbol] is measured, since [symbol] z^{(j)}|\tilde{z}^{(j)} [symbol] =cosⁿ ϵ≥1−nc²/2, the probability of getting |z^{(j)} [symbol] is |z^{(j)}|\tilde{z}^{(j)}|²≥1−ne². The probability of failure is then at most ne². If

$$ϵ \leq \frac{1}{2 \sqrt{n}} ,$$

then the failure probability is at most ¼. If there are M repetitions of the propagation from |\tilde{z}^{(j-1)} [symbol] to |\tilde{z}^{(j)} [symbol] and record the measurement outcomes, then the probability that the majority of the repetitions return a wrong state is bounded from above by Chernoff inequality. The Chernoff inequality states that for independent and identically distributed 0-1 variables X₁ through X_{M}, where each Xᵢ has ½+ξ probability of being 1 and ½−ξ probability of being 0, the probability that X₁+ . . . +XM≤m/2 is at most e^{-2ξ}^{³}^{M}. If the identification

$$ϵ = \frac{1}{2 \sqrt{n}}$$

is used, the failure probability is further restricted to be within some tolerance η, the minimum number of repetitions is M≥8 ln(1/η). For η=10⁻⁹, namely one in a billion, the number of repetitions has to be at least 166. After M repetitions are executed and the majority string is identified, the propagation is run again to obtain the majority string. This extra runs should contain only 1/| [symbol] z^{(j)}|\tilde{z}^{(j)}|²≤1+ne²+ . . . ∈O(1) repetitions on average.

Once the state |z^{(j)} [symbol] is prepared, the same procedure may be continued for propagating from the j-th layer to the (j+1)-st layer. The total number of applications of k-iteration RUS circuit needed for propagating from |\tilde{z}⁽⁰⁾ [symbol] to |\tilde{z}^{(l)} [symbol] is then O(nMl) with n being the maximum layer size. The probability that the majority outcome of measuring is the same as the corresponding layer |z⁽ⁱ⁾ [symbol] in the classical network is then (1−η)^{l}, with η being the error probability for the propagation of a single layer to the next. The total error probability is then v=1−(1−η)^{l}=O(nl). Then combining Equation 32 and the above estimate yields the time cost for simulating, with success probability at least 1−ν and error at most ϵ, an l-layer classical deep feedforward neural network with layer size at most n and weights/bias setting described in Equation 28:

$$O ( \frac{{n}^{3.075} 𝓁}{{δ}^{2.075} {ϵ}^{3.15}} log ( \frac{𝓁}{v} ) ) . \qquad Equation 34$$

The total number of qubits needed for the simulation can then be characterized as

$$O ( n 𝓁 + log \frac{n}{{δϵ}^{1.52}} ) , \qquad Equation 35$$

which is almost linear in the number of neurons in the classical feedforward neural network. From Equation 34, it may be seen that if the number of layers is constant, then assuming the other error parameters ν, δ and ϵ are constant, the quantum neural network runs in roughly O(n²l) time, which has only a linear overhead compared with the classical case, which requires O(n²l) computation due to the bipartite structure of how each layer is connected to its next layer.

Exemplary training of the quantum neural network is described below.

The above discussion shows the explicit connection between our quantum neural network and its classical counterpart. Specifically we assume that the input state is a computational basis state |z⁽⁰⁾ [symbol] that corresponds to some classical input. However, in general one could imagine having a superposition of training data as inputs (refer to Equation 2 for notation definition):

$$\frac{1}{\sqrt{T}} {\sum }_{j = 1}^{T} \vert {x}_{j} 〉 \vert {y}_{j} 〉 \qquad Equation 36$$

where the register holding |xⱼ [symbol] is the input layer of the quantum neural network and an ancilla qubit is introduced for holding the state |yⱼ [symbol] , which is the correct label for each of the training data xⱼ. It is assumed that such state can be prepared by a quantum oracle O_{data} such that O_{data}|xⱼ [symbol] 0 [symbol] =|xⱼ [symbol] |yⱼ [symbol] . Querying the oracle with a uniform superposition of |xⱼ [symbol] states yields the state in Equation 36. The state in the input layer is then propagated through the quantum neural network. The accuracy of training is quantified by the measurement of (ZZ) on both the output qubit holding the state |\tilde{z}^{(l)} [symbol] and the ancilla qubit with the state |yⱼ [symbol] . The expectation value [symbol] [symbol] ranges between −1 and 1, with [symbol] [symbol] =1 signifying perfect training. Hence the training problem is formulated as finding the assignment of weights and biases satisfying Equation 28 such that the [symbol] [symbol] value is maximized.

Consider a (classical) Hopfield network of n neurons each can be in state −1 or 1. At each update, a particular neuron i is chosen and its state xᵢ is assigned to 1 if the total input weights from the other n−1 neurons are larger than some threshold and 0 otherwise. Such assignment operation can be irreversible because the final state of the neuron being updated is independent from its state before the update. To realize such assignment on a quantum computer, however, such irreversibility is avoided by considering a reversible version of the same operation.

The basic construction of the Hopfield network of quantum neurons is to introduce n qubits, one for each neuron in the classical Hopfield net. Assume the n qubits are in a computational basis state corresponding to the state of the classical Hopfield net before the update. The total input weight on neuron i during the update step is simulated by applying controlled rotation by angle 2wⱼᵢi with qubit j as the control and qubit i as the target. Here wⱼᵢi is the weight between neurons j and i. A loop is performed over all j≠i between 1 and n, followed by a rotation on qubit i by angle Δ=π/4−Σⱼwⱼᵢ. This sequence of operations is denoted as U.

To realize the threshold dynamics of the update step, k ancilla qubits are introduced for the iterative repeat-until-success circuits. The result is an ancilla qubit that is in state |0 [symbol] if the total weight Σ_{j≠i}wⱼᵢxⱼ<0 and |0 [symbol] otherwise. This qubit is called the new neuron i and its state is used for the next update. In general, let bᵢ^{(j)}∈{0, 1} be the state of neuron i at the j-th update. Then after a sequence of t updates with the k-th update choosing neuron ik, the state is of the form

|b₁⁽⁰⁾. . . bₙ⁽⁰⁾bᵢ_{₁}⁽¹⁾bᵢ_{₂}⁽²⁾. . . bᵢ_{ₜ}^{(t)} [symbol] Equation 37

where bᵢ_{ₖ}^{(k)} is the state of neuron iₖ. The state above records a history of how the state has evolved over the updates. For a superposition of initial states xⱼ∈{0, 1}ⁿ the corresponding history states for t updates is hⱼ∈{0, 1}^{n+t}.

In case one wants to estimate the fraction of initial states that leads to a particular attractor y∈{0, 1}ⁿ, the superposition may be leveraged to yield a quadratic speedup in such evaluation by amplitude estimation. First, an ancilla qubit is introduced initialized in |0 [symbol] state. For a fixed sequence of updates i₁, i₂, . . . , iₜ, let mⱼ=max{τ=1, . . . , t|i^{r}=j}. Then define a controlled gate which flips the ancilla qubit to |1 [symbol] iff b₁^{(m}^{₁}^{)b}₂^{(m}^{₂}^{) . . . b}ₙ^{(m}^{ₙ}⁾=y. The Grover's oracle could then be defined as a Z gate on the ancilla qubit—giving a phase of −1 iff the history state gives y as its final state. For an initial state which is an even superposition of M different initial states xⱼ of the Hopfield net, one needs only O(√M) steps for estimating the fraction of the initial states that will lead to the attractor y after t updates. On a classical computer, however, one usually needs to iterate through all initial states in question, costing O(M) steps.

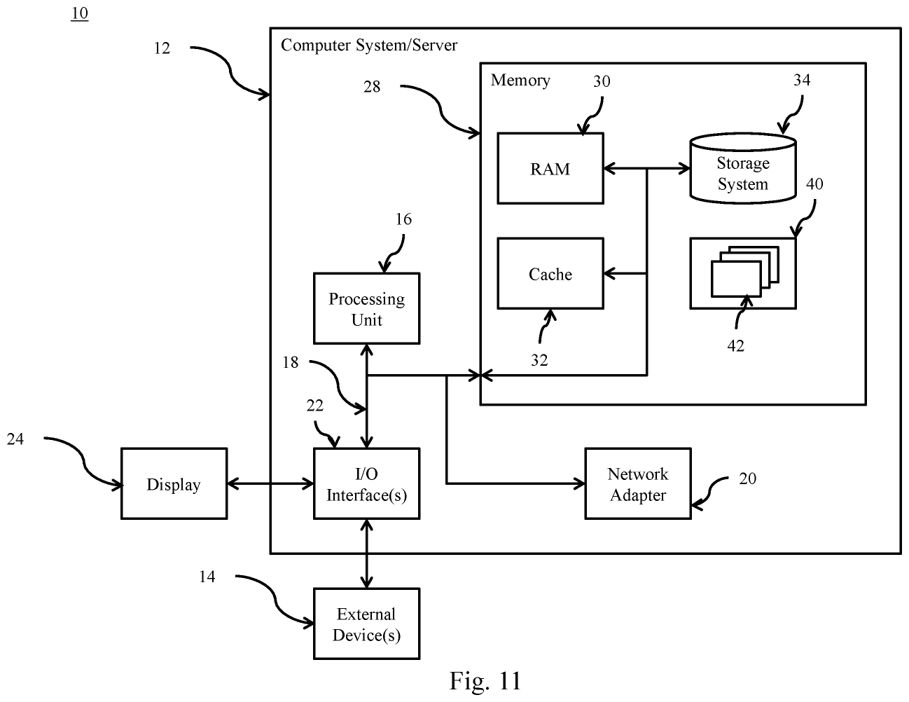

Referring now to FIG. 11, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 11, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of configuring a quantum circuit,
the quantum circuit comprising a first Repeat-Until-Success (RUS) circuit that includes:
an input register, comprising at least one input qubit;
an ancilla qubit; and
an output qubit,
the method comprising:
encoding an input quantum state in the at least one input qubit; and
applying the first RUS circuit to the ancilla qubit and to the output qubit of the first RUS circuit,
wherein the first RUS circuit is controlled by the input quantum state.

2. The method of claim 1, further including:
jointly measuring a quantum state of the output qubit and the quantum state of the at least one input qubit.

3. The method of claim 1, wherein the input register of the first RUS circuit comprises a plurality of input qubits, and wherein the first RUS circuit is controlled by a signal representing a weighted sum of quantum states of the input qubits.

4. The method of claim 1, wherein the quantum circuit further includes a second RUS circuit that includes:
an input register, comprising at least one input qubit;
an ancilla qubit; and
an output qubit,
and further wherein:
the output qubit of the first RUS circuit is the input qubit of the second RUS circuit.

5. A method of training a Feed Forward Quantum Neural Network (FFQNN),
the FFQNN comprising:
an input layer;
optionally, one or more hidden layers, which, if existing, are in communication with the input layer; and
an output layer, in communication with the one or more hidden layers, if existing, or in direct communication with the input layer otherwise,
each layer including at least one qubit,
the method comprising:
providing a training register including at least one qubit;
causing quantum entanglement between the training layer and the input layer;
encoding an input quantum state in the input layer;
propagating the input quantum state from the input layer, optionally, through the one or more hidden layers, to the output layer; and
making a correlated measurement between the at least one qubit of the training register and the at least one qubit of the output layer,
wherein:
the qubits of any two precedent and subsequent layers of the FFQNN that are in direct communication are configured to form a Repeat-Until-Success (RUS) circuit that includes:
an input register, comprising at least one input qubit;
an ancilla qubit; and
an output qubit;
the input register of the RUS circuit includes qubits of the precedent layer, and the output qubit of the RUS circuit are the qubits of the subsequent layer; and
propagating the quantum state between the precedent and subsequent layers of the FFQNN that are in direct communication includes applying the RUS circuit, controlled by the precedent layer, to the qubits in the subsequent layer.

6. A method of updating a Hopfield Quantum Neural Network (HQNN),
the HQNN comprising:
a plurality of nodes, each node in communication with every other node, each node including at least one qubit,
the method comprising:
encoding an input quantum state in the qubits; and
updating the HQNN,
wherein updating the HQNN comprises:
designating a node as a selected node;
configuring a Repeat-Until-Success (RUS) circuit that includes:
an input register;
an ancilla qubit; and
an output qubit;
wherein the input register of the RUS circuit includes the qubits of the plurality of nodes, and the output qubit of the RUS circuit is a qubit of a new node; and
applying the RUS circuit, controlled by the input register, to the qubit of the new node.

7. The method of claim 6, further including replacing the selected node with the new node.

8. The method of claim 1, wherein the quantum circuit further includes at least one additional qubit, the method further including:
encoding a quantum state of the at least one additional qubit under a joint control of the output qubit and the at least one qubit of the input register.

9. A method of configuring a Quantum Autoencoder Neural Network (QANN),
the QANN comprising:
an input layer;
at least one hidden layer in direct communication with the input layer; and
an output layer, in direct communication with at least one hidden layer,
each layer including at least one qubit,
the method comprising:
encoding an input quantum state in the input layer;
propagating the input quantum state from the input layer, through the at least one hidden layer, to the output layer; and
making a correlated measurement between the at least one qubit of the input layer and the at least one qubit of the output layer, thereby configuring the QANN, wherein:
the qubits of any two precedent and subsequent layers of the QANN that are in direct communication are configured to form a Repeat-Until-Success (RUS) circuit that includes:
an input register, comprising at least one input qubit;
an ancilla qubit; and
an output qubit;
the input register of the RUS circuit includes qubits of the precedent layer and the ancilla qubit and the output qubit of the RUS circuit are the qubits of the subsequent layer; and
propagating the quantum state between the precedent and subsequent layers of the QANN that are in direct communication includes applying the RUS circuit, controlled by the precedent layer, to the qubits in the subsequent layer.

10. A quantum circuit, comprising:
a first Repeat-Until-Success (RUS) circuit that includes:
an input register, comprising at least one input qubit;
an ancilla qubit; and
an output qubit,
wherein:
the at least one input qubit configured to encode an input quantum state;
the first RUS circuit is configured to the ancilla qubit and to the output qubit of the first RUS circuit,
wherein the first RUS circuit is controlled by the input quantum state.

11. The quantum circuit of claim 10, further including a second RUS circuit that includes:
an input register, comprising at least one input qubit;
an ancilla qubit; and
an output qubit,
and further wherein:
the output qubit of the first RUS circuit is the input qubit of the second RUS circuit.

12. The quantum circuit of claim 10, further including at least one additional qubit, the circuit configured to encode a quantum state of the at least one additional qubit under a joint control of the output qubit and the at least one qubit of the input register.

13. A Feed Forward Quantum Neural Network (FFQNN), comprising:
a training register including at least one qubit;
an input layer;
optionally, one or more hidden layers, which, if existing, are in communication with the input layer; and
an output layer, in communication with the one or more hidden layers, if existing, or in direct communication with the input layer otherwise, each layer including at least one qubit,
wherein:
the training register and the input layer are configured to be in a state of quantum entanglement;
the input layer is configured to encode an input quantum state;
the FFQNN is configured to make a correlated measurement between the at least one qubit of the training register and the at least one qubit of the output layer; wherein:
the qubits of any two precedent and subsequent layers of the FFQNN that are in direct communication are configured to form a Repeat-Until-Success (RUS) circuit that includes:
an input register, comprising at least one input qubit;
an ancilla qubit; and
an output qubit;
the input register of the RUS circuit includes qubits of the precedent layer, and the ancilla qubit and the output qubit of the RUS circuit are the qubits of the subsequent layer; and
the FFQNN is configured to propagate the quantum state between the precedent and subsequent layers of the FFQNN that are in direct communication by applying the RUS circuit, controlled by the precedent layer, to the qubits in the subsequent layer.

14. A Hopfield Quantum Neural Network (HQNN), comprising:
a plurality of nodes, each node in communication with every other node, each node including at least one qubit, the qubits configured to encode an input quantum state,
wherein the HQNN is configured to:
designate a node as a selected node;
form a Repeat-Until-Success (RUS) circuit that includes:
an input register;
an ancilla qubit; and
an output qubit, wherein the input register of the RUS circuit includes the qubits of the plurality of nodes, and the output qubit of the RUS circuit is a qubit of a new node; and
apply the RUS circuit, controlled by the input register, to the qubit of the new node.

15. The Hopfield Quantum Neural Network of claim 14, further configured to replace the selected node with the new node.

16. A Quantum Autoencoder Neural Network (QANN), comprising:
an input layer;
at least one hidden layer, in direct communication with the input layer; and
an output layer, in direct communication with the at least one hidden layer, each layer including at least one qubit,
the QANN configured to:
encode an input quantum state in the input layer;
propagate the input quantum state from the input layer, through the at least one hidden layer, to the output layer; and
to make a correlated measurement between the at least one qubit of the input layer and the at least one qubit of the output layer, thereby configuring the QANN,
wherein:
the qubits of any two precedent and subsequent layers of the QANN that are in direct communication are configured to form a Repeat-Until-Success (RUS) circuit that includes:
an input register, comprising at least one input qubit;
an ancilla qubit; and
an output qubit;
the input register of the RUS circuit includes qubits of the precedent layer and the ancilla qubit and the output qubit of the RUS circuit are the qubits of the subsequent layer; and
the QANN is configured to propagate the quantum state between the precedent and subsequent layers of the QANN that are in direct communication by applying the RUS circuit, controlled by the precedent layer, to the qubits in the subsequent layer.
